(19) United States
(12) Patent Application Publication
(10) Pub. No.: US 2018/0068345 A1
(43) Pub. Date: Mar. 8, 2018

(54) INFORMATION PROCESSING APPARATUS, METHOD OF PROCESSING INFORMATION, AND STORAGE MEDIUM

(71) Applicants: Tatsuma HIROKAWA, Kanagawa (JP); Mari TATEZONO, Tokyo (JP); Keiichiro HITOMI, Kanagawa (JP)

(72) Inventors: Tatsuma HIROKAWA, Kanagawa (JP); Mari TATEZONO, Tokyo (JP); Keiichiro HITOMI, Kanagawa (JP)

(21) Appl. No.: 15/697,030

(22) Filed: Sep. 6, 2017

(30) Foreign Application Priority Data
Sep. 8, 2016 (JP) 2016-175656
Jul. 27, 2017 (JP) 2017-145942

(51) Int. Cl. G06Q 30/02; H04N 1/00

(52) U.S. Cl. CPC G06Q 30/0251; H04N 1/00244; H04N 1/00392; G06Q 30/02; H04N 1/00477; H04N 2201/0094; H04N 1/00411

(57) ABSTRACT

An information processing apparatus includes processors to control a display of a setting information reception screen used to receive setting information, and an execution instruction of information processing, a primary memory to store a primary application used for requesting the processors to execute the information processing based on the setting information and the execution instruction, and a secondary memory to store a secondary application, and a function providing application. When the secondary application receives an instruction, the secondary application transfers the instruction to the function providing application. The function providing application displays the setting information reception screen on a display after receiving a request for displaying the setting information reception screen from the secondary application, and requests the execution of the information processing based on the setting information and the execution instruction to the primary application after receiving a request for executing the information processing from the secondary application.

### CROSS-REFERENCE TO RELATED APPLICATION

This application claims priority pursuant to 35 U.S.C. §119(a) to Japanese Patent Application Nos. 2016-175656, filed on Sep. 8, 2016, and 2017-145942, filed on Jul. 27, 2017 in the Japan Patent Office, the disclosure of which is incorporated by reference herein in its entirety.

### BACKGROUND

### Technical Field

This disclosure relates to an information processing apparatus, a method of processing information, and a storage medium.

### Background Art

Image forming apparatuses including various types of image forming functions such as copy function, scanner function and printing function are known. As to these image forming apparatuses, it is desirable from the viewpoint of improving competitiveness in the market that many application programs (hereinafter, application) are developed by many third vendors. Therefore, manufacturers of the image forming apparatuses provide application program interfaces (APIs) of the image forming apparatuses to the public to assist or facilitate application development at each of the third vendors. Each of the third vendors develops the applications of the image forming apparatuses based on the APIs available to the third vendors.

In one technology, when a new model is developed for an image forming apparatus, the API of the image forming apparatus is changed and then previous application has become non-compliant to the API of the image forming apparatus. Therefore, even if the non-compliant previous application calls the API, an abnormal operation of the image forming apparatus can be prevented. As to this image forming apparatus, support decision information indicating the API supported by the image forming apparatus is informed to the application. With this configuration, a calling of the API which is not supported by the image forming apparatus is not performed, with which abnormal operation can be prevented.

However, even if the application is developed using the API, the application development process by the third vendors may not be reduced, and the API available to the third vendors may not contribute to the reduction of the application development effort of the third vendors. Further, each time a new model of the image forming apparatus is released, the third vendors need to apply a modification corresponding to the new model to the application developed by the third vendors, and this modification requires a greater effort.

### SUMMARY

In one aspect of the present invention, an information processing apparatus is devised. The information processing apparatus includes one or more processors that cooperate with each other to control an operation related to information processing, and a display operation of displaying a setting information reception screen on a display, the setting information reception screen is used to receive setting information related to the information processing, and an execution instruction of the information processing, a primary memory configured to store a primary application used for requesting the one or more processors to execute the information processing based on the setting information and the execution instruction related to the information processing received via the setting information reception screen, and a secondary memory configured to store a secondary application, different from the primary application, and a function providing application. When the secondary application receives an instruction related to the information processing via the setting information reception screen, the secondary application transfers the instruction related to the information processing to the function providing application. The function providing application displays the setting information reception screen on the display when the function providing application receives a request for displaying the setting information reception screen from the secondary application. The function providing application requests the execution of the information processing based on the setting information and the execution instruction, received via the setting information reception screen and the secondary application, to the primary application when the function providing application receives a request for executing the information processing from the secondary application.

In another aspect of the present invention, a method of processing information in an information processing apparatus including the one or more processors configured to control an operation related to information processing in the information processing apparatus, a primary memory configured to store a primary application, and a secondary memory configured to store a secondary application, different from the primary application, and a function providing application is devised. The method includes inputting an instruction related to the information processing, by using an initial screen displayed on a display, the instruction being any one of a display request of a setting information reception screen and an execution instruction of the information processing, displaying the setting information reception screen on the display by using the function providing application in response to receiving the display request of the setting information reception screen from the secondary application, receiving an input of setting information and a request for executing the information processing, input by using the setting information reception screen displayed on the display, by the secondary application, and requesting the execution of information processing to the primary application from the function providing application based on the setting information and the execution instruction, received via the setting information reception screen, in response to receiving the execution instruction of the information processing by the function providing application from the secondary application.

In another aspect of the present invention, a non-transitory storage medium storing one or more instructions that, when executed by the one or more processors, cause the one or more processors to execute a method of processing information in an information processing apparatus including the one or more processors configured to control an operation related to information processing in the information processing apparatus, a primary memory configured to store a primary application, and a secondary memory configured to store a secondary application, different from the primary application, and a function providing application is devised. The method includes inputting an instruction related to the information processing, by using an initial screen displayed on a display, the instruction being any one of a display request of a setting information reception screen and an execution instruction of the information processing, displaying the setting information reception screen on the display by using the function providing application in response to receiving the display request of the setting information reception screen from the secondary application, receiving an input of setting information and a request for executing the information processing, input by using the setting information reception screen displayed on the display, by the secondary application, and requesting the execution of information processing to the primary application from the function providing application based on the setting information and the execution instruction, received via the setting information reception screen, in response to receiving the execution instruction of the information processing by the function providing application from the secondary application.

### BRIEF DESCRIPTION OF THE DRAWINGS

A more complete appreciation of the description and many of the attendant advantages and features thereof can be readily obtained and understood from the following detailed description with reference to the accompanying drawings, wherein:

FIG. 1 is an example of a hardware configuration of an information processing apparatus of a first embodiment;

FIG. 2 is an example of a software configuration of the information processing apparatus of the first embodiment;

FIG. 3 is an example of software installed in the information processing apparatus of the first embodiment;

FIG. 4 is an example of a functional block diagram of a function providing application installed in an operation unit of the information processing apparatus of the first embodiment;

FIG. 5 is an example of a sequential chart illustrating a sequence of an operation of a function providing application when a scan execution operation is performed by a vendor application;

FIG. 6 is an example of a home screen displayed as an initial screen on an operation panel of an operation unit;

FIG. 7 is an example of a main screen of a vendor application;

FIG. 8 is an example of a setting screen used for a scan setting operation;

FIG. 9 is an example of a setting screen of a setting item operated by a user;

FIG. 10 is an example of a screen displaying that scanning is being executed;

FIG. 11 is another example of a sequential chart illustrating a sequence of an operation of a function providing application when a scan setting button and a scan execution button are displayed collectively;

FIG. 12 is another example of a main screen of a vendor application when a scan setting button and a scan execution button are displayed collectively;

FIG. 13 is an example of a top screen of a function providing application when a scan setting button and a scan execution button are e displayed collectively;

FIG. 14 is an example of a detail setting screen corresponding to a specific setting item displayed on a top screen of a function providing application operated by a user when a scan setting button and a scan execution button are displayed collectively;

FIGS. 15A and 15B illustrates a communication route between a vendor application and a function providing application intermediated by an OS layer of an operation unit in the information processing apparatus of the first embodiment;

FIG. 16 is an example of a display style of a color setting item when a user-initiating setting operation to the color setting item is designated with “enable”, and a display style of the color setting item when a user-initiating setting operation to the color setting item is designated with “disable”;

FIGS. 17A, 17B, and 17C are examples of display style of setting items on a scan setting screen of a function providing application;

FIG. 18A is an example of a scan setting screen displaying a scan size setting item, and FIG. 18B is an example of a scan setting screen when a scan size setting item is set with “invisible,” in which a function providing application displays a subsequent setting item at a display position of the scan size setting item set with “invisible”;

FIG. 19 is an example of a standard display style of a setting screen of a function providing application;

FIG. 20 is an example of a display style of a setting screen of a function providing application when the function providing application sets a color setting item as “invisible,” and displays a subsequent file format setting item at a display position of the color setting item by shifting the file format setting item;

FIG. 21 is an example of a display style of a setting screen displayed by a function providing application when setting of the color setting item by a user is set with “disable,” in which the color setting item is displayed with semitransparent transparency;

FIG. 22A is an example of standard arrangement of setting items on a scan setting screen, and FIG. 22B is an example of another arrangement of the setting items on the scan setting screen when a color setting item and a format setting item are exchanged with each other, in which the function providing application displays the file format setting item at first, and then displays the color setting item;

FIG. 23 is an example configuration when a plurality of vendor applications are stored in an operation unit;

FIG. 24 is an example of application data stored in a storage unit by a storage control unit of a function providing application;

FIG. 25 is an example of a sequential chart illustrating a sequence of an operation by a function providing application when a plurality of vendor applications is stored in an operation unit, in which the function providing application displays a setting screen requested by one of the vendor applications based on a display status and a job execution status of each one of the vendor applications;

FIG. 26 is an example of a sequential chart illustrating a sequence of an operation by a function providing application when a plurality of vendor applications is stored in an operation unit, in which the function providing application executes a job requested by one of the vendor applications based on a display status and a job execution status of each one of the vendor applications;

FIG. 27 is an example of software installed in an information processing apparatus of a second embodiment;

FIG. 28 is a functional block diagram of a function providing application provided in the information processing apparatus of the second embodiment;

FIG. 29 is an example of a home screen of the information processing apparatus of the second embodiment;

FIG. 30 is an example of a setting screen of a scanner function providing application in the information processing apparatus of the second embodiment;

FIG. 31 is an example of a setting screen of a file format of a scanner function providing application in the information processing apparatus of the second embodiment;

FIGS. 32A and 32B are a sequential chart of a first half of a display operation of a setting screen for the information processing apparatus of the second embodiment;

FIGS. 33A and 33B are a sequential chart of a second half of a display operation of a setting screen for the information processing apparatus of the second embodiment; and

FIGS. 34A and 34B are a sequential chart illustrating a job execution in the information processing apparatus of the second embodiment.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of present disclosure. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of present disclosure.

In addition, it should be noted that the terminology used herein is for the purpose of describing particular embodiments only and is not intended to be limiting of present disclosure. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. Furthermore, although in describing views illustrated in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, one or more apparatuses or systems according to one or more embodiments are described hereinafter.

### First Embodiment

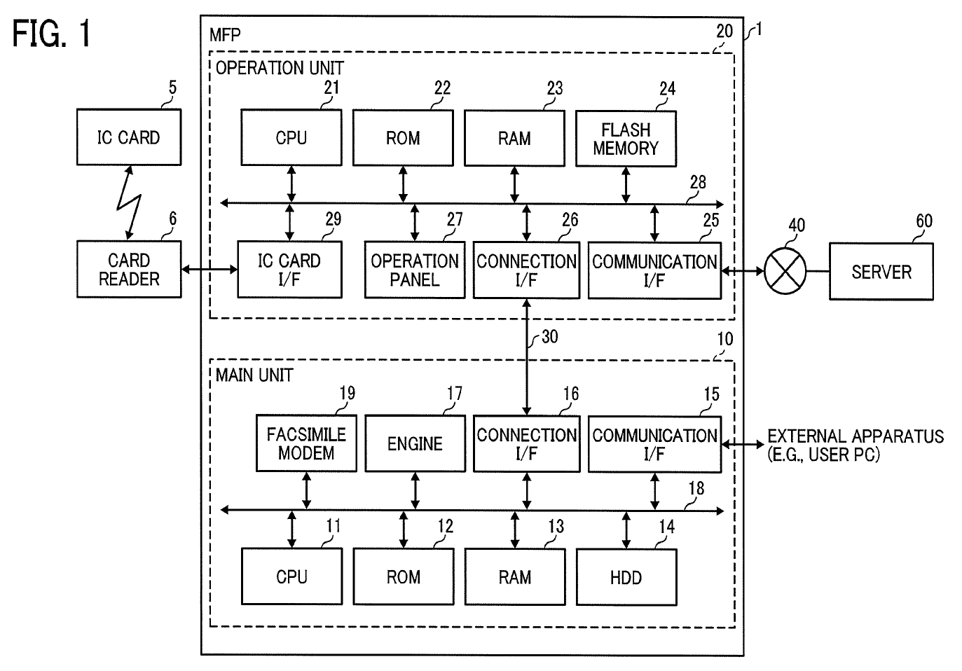

FIG. 1 is an example of a hardware configuration of a multifunction peripheral (MFP) 1 of a first embodiment, in which the MFP 1 is an image processing apparatus which is an example of information processing apparatuses. As illustrated in FIG. 1, the MFP 1 includes, for example, a main unit 10, and an operation unit 20. The main unit 10 includes various types of image forming functions such as a copy function, a scanner function, a facsimile function, and a printer function, and the operation unit 20 receives various input by a user's operation.

As illustrated in FIG. 1, the main unit 10 and the operation unit 20 are connected with each other via a communication path 30 to communicate with each other. The communication path 30 can use, for example, a universal serial bus (USB) standard. Further, the communication path 30 can use any standards of wired or wireless communication. Further, the main unit 10 can include at least any one of copy function, scanner function, facsimile function, and printer function among various types of image forming functions, or can include a plurality of functions among various types of image forming functions.

The operation unit 20 can be, for example, an electronic device that can perform information processing. For example, the operation unit 20 can be an information processing terminal such as a smartphone, a tablet terminal or the like. In this disclosure, the information processing terminal used as the operation unit 20 can be used as the operation unit of the MFP 1.

More specifically, conventionally, when an information processing terminal used as the operation unit, an exclusive use operation panel is fixed as the operation unit in the MFP. By contrast, the operation unit 20 used for the MFP 1 of the first embodiment is attachable to and removable from the main unit 10 of the MFP 1. Specifically, the operation unit 20 used as the information processing terminal is removable or detachable from a given position of the MFP 1 such as a position where the operation panel is disposed, and is attachable to the MFP 1. Therefore, the operation unit 20, used as the information processing terminal, and the MFP 1 can be used as one apparatus. When the operation unit 20 used as the information processing terminal is removed from the MFP 1, the operation unit 20 communicates with the MFP 1 by using a wireless communication standard such as Bluetooth (registered trademark) or infrared communication, in which the operation unit 20 can be used as the operation unit of the MFP 1.

The main unit 10 performs operations corresponding to various inputs received from the operation unit 20. Further, the main unit 10 can communicate with an external apparatus such as a user personal computer (PC), and the main unit 10 can perform operations corresponding instructions received from the external apparatus.

### (Hardware Configuration of Main Unit)

A description is given of a hardware configuration of the main unit 10. As illustrated in FIG. 1, the main unit 10 includes, for example, a central processing unit (CPU) 11, a read only memory (ROM) 12, a random access memory (RAM) 13, and a hard disk drive (HDD) 14. The main unit 10 further includes, for example, a communication interface (I/F) 15, a connection interface (I/F) 16, an engine 17, and a facsimile modem 19. Each of the units 11 to 17 and the facsimile modem 19 are mutually connected via a system bus 18.

The CPU 11 controls operations of the main unit 10 entirely. The CPU 11 executes programs stored in the ROM 12 and/or the HDD 14 by using the RAM 13 as a working area to control operations of the main unit 10 entirely, with which the CPU 11 can implement various types of image forming/generation functions such as the above described copy function, scanner function, facsimile function, and printer function. The CPU 11 can be referred to as a primary processor or circuitry in this disclosure. Further, the HDD 14 of the main unit 10 can be replaced by a flash memory.

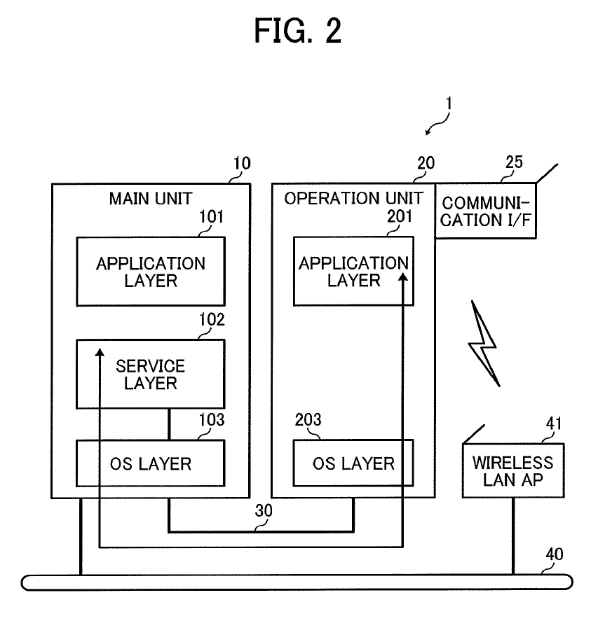

The communication I/F 15 is used as an interface to communicate with an external apparatus on a network 40 such as a user PC, a Web server, and a verification server. The connection I/F 16 is used as an interface to communicate with the operation unit 20 via the communication path 30. In FIG. 1 and FIG. 2, although the communication path 30 is illustrated with a solid line, which may indicate a wire, as described above, the operation unit 20 is attachable to and removable from the main unit 10 of the MFP 1. Therefore, when the operation unit 20 is attached to the MFP 1, the communication path 30 becomes a wired communication path, and when the operation unit 20 is removed from the MFP 1, the communication path 30 becomes wireless communication path.

The engine 17 is a hardware that performs various processing such as copy function, scanner function, facsimile function, and printer function while the engine 17 is used not used for general information processing and general communication processing. The engine 17 includes, for example, a scanner that scans document image, a plotter that prints images on sheets such as paper, and a facsimile communication unit that performs a facsimile communication. Further, the engine 17 can include options such as a finisher that sorts printed sheets, and an automatic document feeder (ADF) that feeds documents automatically.

### (Hardware Configuration of Operation Unit)

A description is given of a hardware configuration of the operation unit 20. As illustrated in FIG. 1, the operation unit 20 includes, for example, a CPU 21, a ROM 22, a RAM 23, a flash memory 24, a communication I/F 25, a connection I/F 26, an operation panel 27, and an integrated circuit (IC) card I/F 29 mutually connected via a system bus 28. Further, the flash memory 24 of the operation unit 20 can be replaced by a hard disk drive (HDD).

The CPU 21 controls operations of the operation unit 20 entirely. The CPU 21 executes programs stored the ROM 22 by using the RAM 23 as a working area to control the operations of the operation unit 20 entirely. Further, the CPU 21 executes a user verification program stored in the ROM 22 or the like to perform a user verification processing. The CPU 21 can be referred to as a secondary processor or circuitry in this disclosure. The communication I/F 25 is used as an interface to communicate with, for example, a server 60 on the network 40. The connection I/F 26 is used as an interface to communicate with the main unit 10 via the communication path 30.

The IC card I/F 29 is, for example, connected to a card reader 6 via a universal serial bus (USB) cable or the like. When an log-in operation of the MFP is performed, a user performs a proximity operation (non-contact operation) of an integrated circuit (IC) card 5 by placing the IC card 5 near the card reader 6, with which the card reader 6 communicates with the IC card 5 without contacting to read verification information stored in the IC card 5 such as card identification (ID), and user information. Further, in this configuration, the card reader 6 can read the verification information from the IC card 5 by contacting the IC card 5 to the card reader 6 in addition to a non-contact operation.

Further, for example, although the card reader 6 and the operation unit 20 are assumed to be physically different devices connected with each other via the USB cable or the like, the card reader 6 can be built in the operation unit 20, which means that the operation unit 20 and the card reader 6 can be integrated as one unit such as one device or apparatus.

Further, any types of storage medium or recording medium can be used as the IC card or ID card for the embodiments, and the embodiments are not limited to use of the IC card or ID card. Further, the card reader can employ any types of card reader that can read information such as user information from the storage medium or recording medium.

The operation panel 27 can employ, for example, a liquid crystal display (LCD) including a touch sensor. The operation panel 27 receives various types of input from a user's operation, and also displays various types of information such as information corresponding to the received input type, information indicating an operation status of the MFP 1, information indicating a setting status. Further, the operation panel 27 can employ, for example, an organic electroluminescence (OEL) display including a touch sensor. Further, in addition these or instead of these, an operation unit such as hardware keys and/or a display such as a light emission unit can be disposed.

### (Software Configuration of MFP)

FIG. 2 is an example of a software configuration of the MFP 1. As illustrated in FIG. 2, the main unit 10 includes, for example, an application layer 101, a service layer 102, and an OS layer 103. Each of the application layer 101, the service layer 102, and the OS layer 103 can be implemented by using various types of software stored in the ROM 12 and/or the HDD 14. When the CPU 11 executes the various types of software, various types of functions can be provided.

The software of the application layer 101 is an application software (hereinafter, “application” or “application software”) that is used to operate hardware resources to provide specific functions. For example, the application can be a copy application that provides a copy function, a scanner application that provides a scanner function, a facsimile application that provides a facsimile function, and a printer application that provides a printing function.

The software of the service layer 102 is disposed between the application layer 101 and the OS layer 103, and provides an interface for an application so that the application can use hardware resources included in the main unit 10. Specifically, the software of the service layer 102 is used to receive an operation request to the hardware resources, and to perform a mediation of operation requests. The operation request that is received by the service layer 102 is, for example, a scanning request by a scanner, a printing request by a plotter.

Further, the interface function of the service layer 102 can be also provided to an application layer 201 of the operation unit 20 in addition to the application layer 101 of the main unit 10. Specifically, the application layer 201 (application) of the operation unit 20 can also implement one or more functions by using the hardware resources (e.g., engine 17) of the main unit 10 through the interface function of the service layer 102.

The software of the OS layer 103 is a basic software (operating system) that provides basic functions to control the hardware resources included in the main unit 10. The software of the service layer 102 converts a usage request of the hardware resources from various types of applications to a command that the OS layer 103 can interpret, and transfers the command to the OS layer 103. Then, when the command is executed by using the software of the OS layer 103, the hardware resources perform an operation requested by the application.

Similarly, the operation unit 20 includes, for example, an application layer 201, and an OS layer 203 as illustrated in FIG. 2. The hierarchical structure of the application layer 201 and the OS layer 203 included in the operation unit 20 is similar to the hierarchical structure of the main unit 10. However, the types of operation request that the functions provided by the applications of the application layer 201 can receive are different compared to the types of operation request that the main unit 10 can receive. The application of the application layer 201 is a software that is used to operate or activate hardware resources included in the operation unit 20 to provide one or more specific functions. For example, the application of the application layer 201 is a software that provides a user interface (UI) function that is used for performing an operation and a display of functions included in the main unit 10 such as copy function, scanner function, facsimile function, and printer function.

Further, as to the MFP 1 of the first embodiment, the software of the OS layer 103 of the main unit 10 and the software of the OS layer 203 of the operation unit 20 are mutually different to maintain independence of functionality of the main unit 10 and the operation unit 20. For example, Linux (registered trademark) is used as the software of the OS layer 103 of the main unit 10, and Android (registered trademark) is used as the software of the OS layer 203 of the operation unit 20. With this configuration, the main unit 10 and the operation unit 20 are designed to be operated independently from each other by using different operating systems.

By operating the main unit 10 and the operation unit 20 using the different operating systems, the communication between the main unit 10 and the operation unit 20 is not communication between processes within a common or same device or apparatus, but the communication between the main unit 10 and the operation unit 20 is communication between different devices or apparatuses. For example, a command communication that transmits an input received by the operation unit 20 (e.g., instruction from a user) to the main unit 10, and a reporting operation of the main unit 10 such as the main unit 10 reports an event to the operation unit 20 is the communication between different devices or apparatuses. In this configuration, when the operation unit 20 performs a command communication to the main unit 10, the function of the main unit 10 can be used. Further, an event reported from the main unit 10 to the operation unit 20 includes, for example, an operation execution status in the main unit 10, and contents set at the main unit 10.

Further, in the first embodiment, electric power is supplied to the operation unit 20 from the main unit 10 via the communication path 30, in which the power control of the operation unit 20 and the control of the main unit 10 can be performed separately.

Further, in the first embodiment, the main unit 10 and the operation unit 20 are electrically and physically connected with each other via the communication path 30. However, as described above, the operation unit 20 can be removed from the main unit 10, in which a short-distance wireless communication unit such as an infrared communication unit, a radio frequency (RF) communication unit, and a Bluetooth (registered trademark) communication unit is disposed for each of the main unit 10 and the operation unit 20. Further, a wireless local area network (LAN) communication function such as Wi-Fi (registered trademark) can be disposed for each of the main unit 10 and the operation unit 20, and then the main unit 10 and the operation unit 20 are configured to communicate with each other via a wireless LAN access point (wireless LAN AP) 41 and the network 40 as illustrated in FIG. 2. When the operation unit 20 is a unit that can be removed from the main unit 10, the operation unit 20 stores electric power supplied from the main unit 10 via the communication path 30 in a secondary battery disposed in the operation unit 20, and when the operation unit 20 is removed from the main unit 10, the operation unit 20 is operated with the electric power stored in the secondary battery to communicate with the main unit 10.

### (Software Installed in MFP)

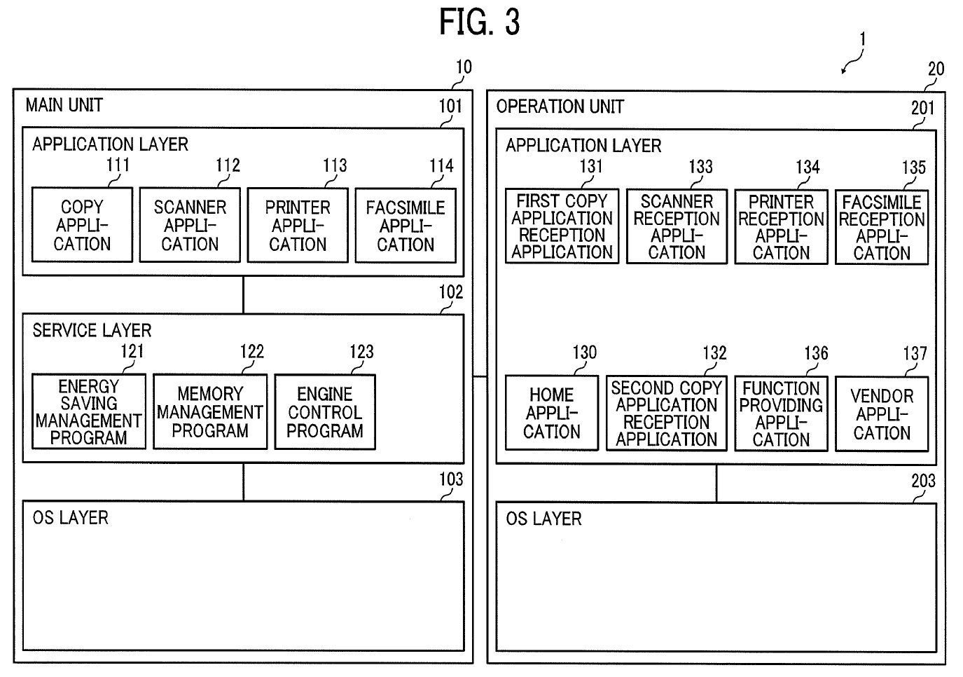

FIG. 3 is an example of software installed in the MFP 1. As described above, the main unit 10 includes a plurality of different layers such as the application layer 101, the service layer 102, and the OS layer 103 as separate layers. The application layer 101 stores one or more applications used for controlling the engine 17 (FIG. 1) such as an application for controlling document scanning, and an application for printing or the like. Specifically, the application layer 101 stores, for example, a copy application 111, a scanner application 112, a printer application 113, and a facsimile application 114 as standard-installed applications or standard-installed job execution function applications. Each of the standard-installed applications is used as primary applications that is used to request one or more operations. The CPU 11 is a processor or circuitry that controls each of the primary applications such as the copy application 111 to the facsimile application 114. For example, the standard-installed applications (e.g., applications 111 to 114) can be stored in a storage unit such as the ROM 12, the RAM 13, and/or the HDD 14 of the main unit 10, which is referred to as a primary memory in this description.

Further, the service layer 102 stores various types of program such as an energy saving management program 121, a memory management program 122, and an engine control program 123, which are the programs for executing common processing used by each of applications. For example, the service layer 102 performs common processing such as energy saving management and memory management used by each of applications.

By contrast, the operation unit 20 includes the application layer 201, and the OS layer 203. The applications installed in the main unit 10, and the applications installed in operation unit 20 perform different processing. Specifically, the applications of the main unit 10 performs the engine control to control functions of the MFP 1 such as scanning data and printing data while the applications of the operation unit 20 performs an user interface (UI) control. For example, the application of the operation unit 20 performs a screen display to receive a user operation via the displayed screen, and the application of the main unit 10 performs the engine control based on the user operation received via the operation unit 20.

Further, the operation unit 20 can include a plurality of applications that performs the same function when different designs (e.g., appearance) are set for the UI, and/or variations are set for the same function. In an example case of FIG. 3, the first copy reception application 131 and the second copy reception application 132 are installed in the operation unit 20. Compared to the first copy reception application 131, the functions included in the second copy reception application 132 is reduced to simplify the appearance of the UI.

Similar to the relationship between the first copy reception application 131 and the second copy reception application 132, for example, a vendor application 137 developed for the scanner application or the like by a development vendor is installed. In order to simplify or facilitate the development of the vendor application 137, the function providing application 136, which is configured to provide functions equivalent to the applications 131 to 135 installed in the operation unit 20 to the vendor, is installed in the operation unit 20.

For example, the application layer 201 stores one or more applications that receive a user operation via a user interface (UI). Specifically, the application layer 201 stores, for example, a home application 130, a first copy reception application 131, a second copy reception application 132, a scanner reception application 133, a printer reception application 134, a facsimile reception application 135, a function providing application 136, and a vendor application 137. The function providing application 136 is an example of image processing program, which is also referred to as an information processing program. Further, the function providing application 136 can be stored in, for example, a storage unit such as the ROM 22, the RAM 23 and/or the flash memory 24 of the operation unit 20, which is referred to as a secondary memory in this description. Further, the vendor application 137 can be also stored in, for example, the storage unit such as the ROM 22, the RAM 23 and/or the flash memory 24 of the operation unit 20 used as the secondary memory. In this description, the vendor application 137 is used as an example of a secondary application that is used to request one or more operations.

The home application 130 displays a home screen (e.g., initial screen) that arranges icons used for designating specific operations. When a user operates a specific icon, a specific application is designated and activated. The first copy reception application 131 is used as an application to receive a copy operation by a user via operation buttons and setting buttons. The second copy reception application 132 is used as an application to display operation buttons and setting buttons used with higher frequency to reduce the number of the displayed operation buttons and setting buttons compared to the first copy reception application 131 to enhance visibility and operability of the operation buttons and setting buttons. The scanner reception application 133 is used as an application that receives a scanner operation by a user via the operation buttons and setting buttons. The printer reception application 134 is used as an application that receives a print operation by a user via the operation buttons and setting buttons. The facsimile reception application 135 is used as an application that receives a facsimile transmission/reception operation by a user via the operation buttons and setting buttons.

In this disclosure, in order to simplify or facilitate development of the vendor application 137, the function providing application 136 provides the functions equivalent to various applications (e.g., applications 131 to 135) installed in the operation unit 20 to the vendor.

Specifically, for example, when the function providing application 136 is used as an application corresponding to the scanner application 112, the function providing application 136 provides a function to display a user interface (UI) such as a standard operation menu and a setting menu to the vendor. Further, for example, when the function providing application 136 is used as an application corresponding to the printer application 113, the function providing application 136 provides a function to display a user interface (UI) such as a standard operation menu and a setting menu to the vendor.

As described above, the operation unit 20 of the MFP 1 is installed with the function providing application 136 for providing functions equivalent to the first copy reception application 131, the second copy reception application 132, the scanner reception application 133, the printer reception application 134, and the facsimile reception application 135 to the vendor. Further, an application programming interface (API) that implements functions of the function providing application 136 is available to development vendors of the vendor application 137.

### (Function of Function Providing Application)

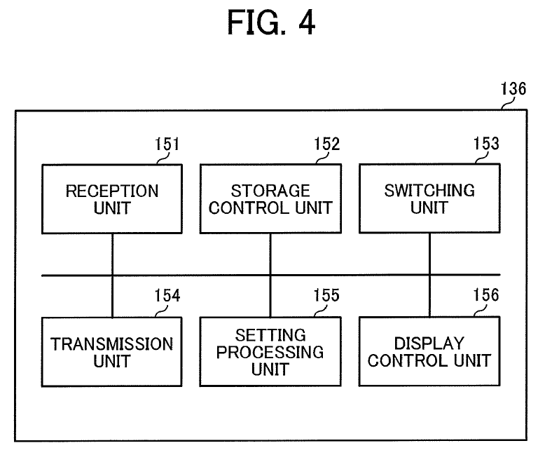

FIG. 4 is an example of a functional block diagram of the function providing application 136. When the CPU 21 of the operation unit 20 implements the function providing application 136 stored in a storage unit such as the ROM 22, the RAM 23 and/or the flash memory 24, a reception unit 151, a storage control unit 152, a switching unit 153, a transmission unit 154, a setting processing unit 155, and a display control unit 156 are implemented as illustrated in FIG. 4.

When a user performs an input operation via the operation panel 27, the reception unit 151 receives a command corresponding to the input operation performed by the user via the operation panel 27, and further, the reception unit 151 receives an execution result from the main unit 10, which is obtained by requesting the execution to the main unit 10. The storage control unit 152 stores applications, and reads out information of application corresponding to a screen display request from the storage unit such as the ROM 22, the RAM 23 and/or the flash memory 24. The switching unit 153 performs a switching of screens on the operation panel 27 based on an operation by a user on the operation panel 27. The transmission unit 154 transmits a specific operation execution request to each one of applications of the main unit 10 such as the copy application 111, and the scanner application 112 of the main unit 10. The setting processing unit 155 performs setting processing such as reporting setting contents set by a user via a setting screen to the vendor application 137. The display control unit 156 performs a display control of a main screen and a setting screen on the operation panel 27.

In the above described configuration, the reception unit 151 to the display control unit 156 are implemented by software programs, but a part or the entire of the reception unit 151 to the display control unit 156 can be implemented by a hardware such as an integrated circuit (IC).

Further, the function providing application 136 can be provided as an installable format file or an executable format file stored in a computer-readable storage medium or recording medium such as compact disc read only memory (CD-ROM), flexible disk (FD), or the like. Further, the function providing application 136 can be provided by being recorded in a computer-readable storage or recording medium such as compact disc-recordable (CD-R), digital versatile disk (DVD), Blu-ray Disc (registered trademark), semiconductor memory, or the like. Further, the function providing application 136 can be provided and installed via a network such as the Internet. Further, the function providing application 136 can be provided by being recorded in a ROM or the like disposed in an apparatus in advance.

### (Operation of Function Providing Application: When Scan Setting Button and Scan Execution Button are Displayed Separately on Main Screen of Vendor Application)

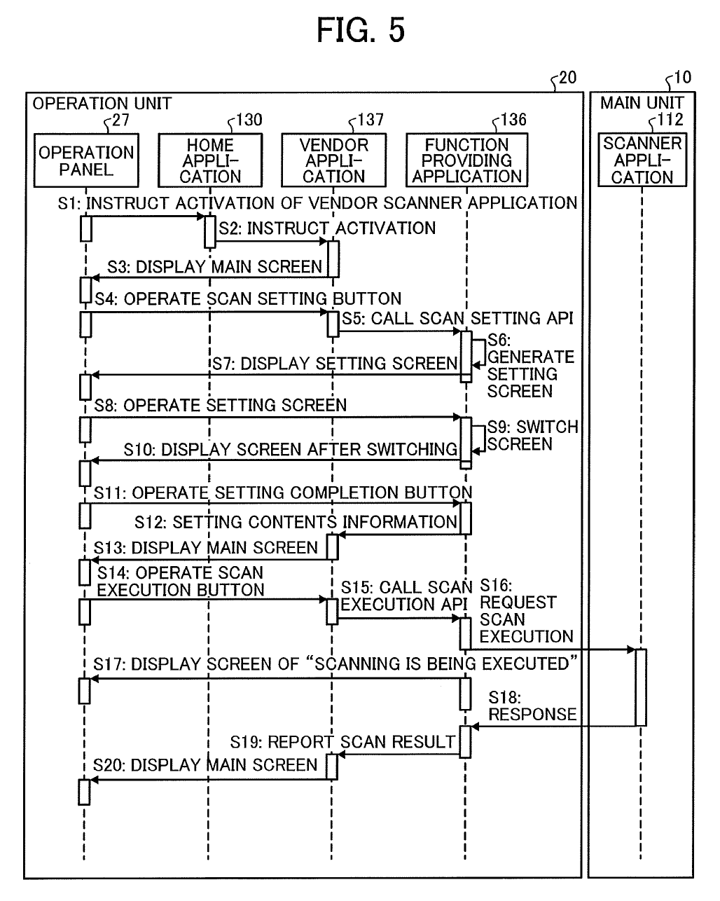

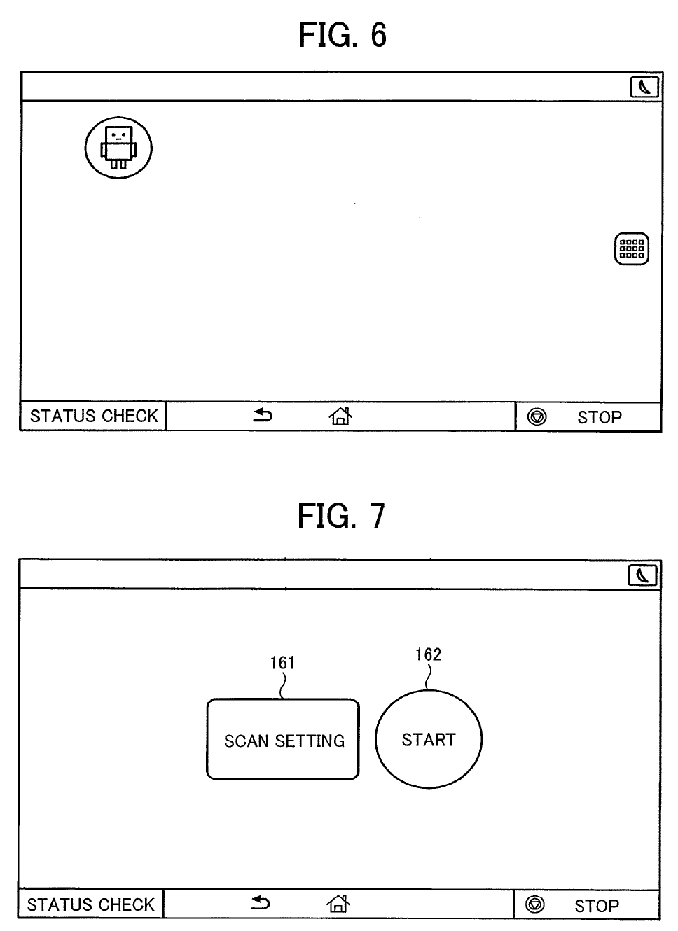

A description is given of an operation of the function providing application 136. FIG. 5 is an example of a sequential chart illustrating a sequence of an operation of the function providing application 136 when a scan execution operation is performed by the vendor application 137. Further, FIG. 6 is an example of a home screen 140 displayed as an initial screen on the operation panel 27 of the operation unit 20. For example, one or more icons used for activating specific applications are displayed on the home screen 140 as illustrated in FIG. 6. In this configuration, a user operates an icon for designating an activation of the vendor application 137 displayed on the operation panel 27 to instruct an activation of the vendor application 137. An instruction signal instructing the activation of the vendor application 137 is transmitted to the home application 130 from the operation panel 27 at step S1.

At step S2, the home application 130 transmits the instruction signal instructing the activation of the vendor application 137 to the vendor application 137. With this configuration, at step S3, the vendor application 137 displays, for example, a main screen illustrated in FIG. 7 on the operation panel 27. The main screen illustrated in FIG. 7 is an example of a screen when the vendor application 137 is an application used for controlling a scanner. As illustrated in FIG. 7, the vendor application 137 displays, for example, a scan setting button 161, and a scan execution button 162 (e.g., start button) on the main screen. The scan setting button 161 is operated when instructing a scan setting operation, and the scan execution button 162 is operated when instructing a scan execution operation.

When the scan setting operation is to be performed, a user operates the scan setting button 161 displayed on the main screen (FIG. 7). When the user operates the scan setting button 161 displayed on the main screen, the operation panel 27 transmits a signal indicating that the scan setting button 161 is operated to the vendor application 137 (step S4). When the vendor application 137 receives the signal indicating that the scan setting button 161 is operated, at step S5, the vendor application 137 makes a call of a scan setting application programming interface (API) to the function providing application 136. At step S6, the setting processing unit 155 of the function providing application 136 generates a setting screen used for the scan setting operation. The display control unit 156 of the function providing application 136 displays the generated setting screen on the operation panel 27 at step S7.

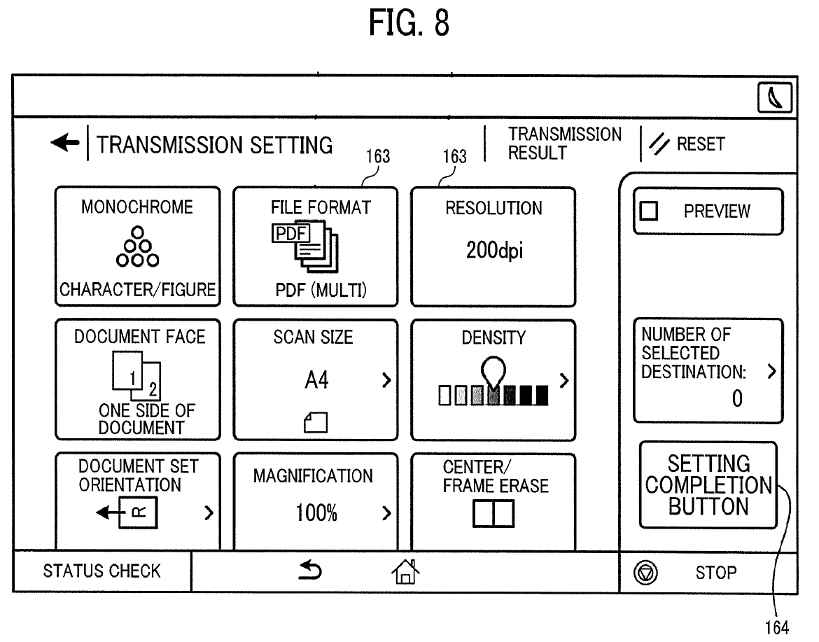

FIG. 8 is an example of a setting screen used for the scan setting operation. As illustrated in FIG. 8, the setting processing unit 155 generates the setting screen including, for example, various icons 163, and a setting completion button 164. The various icons 163 are associated to various types of the setting items related to the scan operation, and the setting completion button 164 is operated when the setting operation is completed. In this description, each of the various icons 163 is referred to as, for example, a density icon 163, a scan size icon 163, and so on. In this description, the setting screen can be used as a setting information reception screen.

When the various icons 163 associated to various types of the setting items are displayed on the setting screen, and then one of the icon 163 associated to a specific setting item is operated by the user, at step S8, a signal indicating that the specific setting item is operated by the user is transmitted from the operation panel 27 to the function providing application 136. The reception unit 151 of the function providing application 136 receives the signal indicating that the specific setting item is operated by the user. Then, at step S9, the switching unit 153 of the function providing application 136 switches a screen from one screen to another screen. Specifically, when the reception unit 151 receives the signal indicating the specific setting item, the switching unit 153 switches the setting screen (first setting screen) to another setting screen (second setting screen) of the specific setting item operated by the user. Then, at step S10, the display control unit 156 of the function providing application 136 displays the second setting screen on the operation panel 27. As above described, a top screen of scanner setting screen (first setting screen) and a detail setting screen (second setting screen) shifted from the top screen of scanner setting screen (first setting screen) are implemented by the function providing application 136.

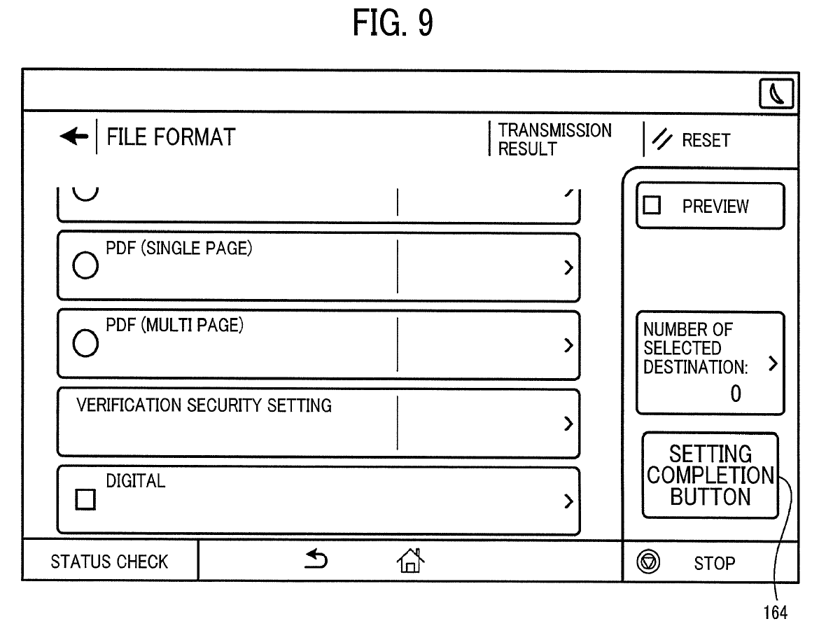

FIG. 9 is an example of a setting screen of a specific setting item operated by a user, in which a file format icon 163 is operated. The user performs a detail setting operation related to the scan operation via the setting screen illustrated in FIG. 9. Then, when the setting operation is completed, the user operates the setting completion button 164. In the operation unit 20, the CPU 21 stores setting contents information set by the user operation in the storage unit such as the RAM 23 and/or the flash memory 24. When the user operates the setting completion button 164, the setting contents information is read out from the storage unit, and then a signal indicating that the setting completion button 164 is operated, and the setting contents information are both transmitted to the function providing application 136 from the operation panel 27.

At step S11, the reception unit 151 of the function providing application 136 receives the signal indicating that the setting completion button 164 is operated, and the setting contents information set by the user. The transmission unit 154 of the function providing application 136 transmits the received setting contents information to the vendor application 137 at step S12. Then, the vendor application 137 updates the setting contents information stored in the above described storage unit such as the RAM 23 and/or the flash memory 24 based on the received setting contents information. Further, after the vendor application 137 stores the setting contents information, the vendor application 137 displays the main screen illustrated in FIG. 7 on the operation panel 27 (step S13).

Further, when the scan execution operation is performed, the user operates the scan execution button 162 (e.g., start button) displayed on the main screen illustrated in FIG. 7. When the user operates the scan execution button 162, a signal indicating that the scan execution button 162 is operated is transmitted from the operation panel 27 to the vendor application 137 (step S14). When the vendor application 137 receives the signal indicating that the scan execution button 162 is operated, at step S15, the vendor application 137 makes a call of a scan execution API to the function providing application 136. Further, the vendor application 137 reads out the above described setting contents information from the storage unit, and transmits the above described read setting contents information to the function providing application 136. The transmission unit 154 of the function providing application 136 transmits the setting contents information and a scan execution request to the scanner application 112 of the main unit 10 at step S16. The scanner application 112 of the main unit 10 controls the scan function of the engine 17 based on the setting contents information. With this configuration, an actual scan operation is performed.

Further, it can be configured that the setting contents information input by the user via the operation panel 27 is stored in the above described storage unit by the storage control unit 152 of the function providing application 136, in which when the vendor application 137 makes a call of the scan execution API, the storage control unit 152 of the function providing application 136 reads out the setting contents information from the storage unit, and transmits the setting contents information to the scanner application 112.

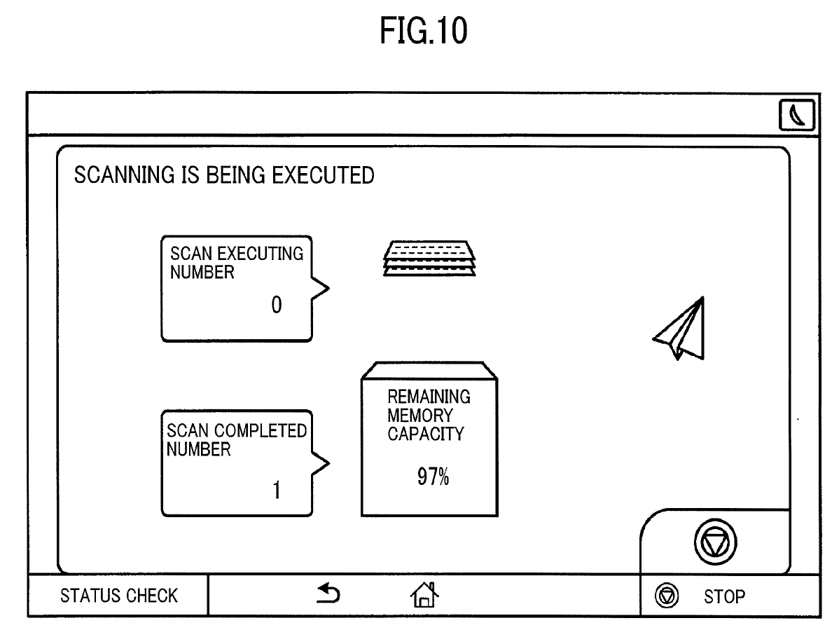

The display control unit 156 of the function providing application 136 generates a screen displaying that the scanning is being executed corresponding to the scan operation being executed by the scanner application 112 of the main unit 10, and displays the screen displaying that the scanning is being executed on the operation panel 27 at step S17. FIG. 10 is an example of the screen displaying that the scanning is being executed. In this example case, the display control unit 156 displays the screen displaying that the scanning is being executed by including, for example, a message of “scan is being executed,” a scan completed number, and a remaining memory capacity that can be used.

Then, when the scan execution operation is completed, the scanner application 112 of the main unit 10 issues one job identification number (hereinafter, job ID) for a plurality of image information acquired by one scan execution operation or one job ID for each one of image information acquired by one scan execution operation. Further, the scanner application 112 associates the issued job ID and the acquired image information, and stores the issued job ID and the associated acquired image information in the storage unit of the main unit 10 such as the HDD 14 and/or the RAM 13. Then, the scanner application 112 transmits the job ID issued for the scan execution operation that was executed based on the scan execution request to the function providing application 136 as a response to the scan execution request at step S18.

Further, in this example case, the job ID is transmitted from the scanner application 112 to the function providing application 136 as a response to the scan execution request, but not limited thereto. For example, the image information acquired by the scan execution operation can be transmitted from the scanner application 112 to the function providing application 136 as the response to the scan execution request at step S18.

When the transmission unit 154 of the function providing application 136 receives the job ID at step S18, the function providing application 136 reports the job ID to the vendor application 137 as a scan result at step S19. When the vendor application 137 receives the job ID, the vendor application 137 stores the reported job ID in the storage unit such as the flash memory 24 and/or the RAM 23. After storing the job ID, the vendor application 137 performs a display control of the main screen illustrated in FIG. 7 on the operation panel 27 at step S20. As above described, the function providing application 136 performs the above described scan setting operation and scan execution operation based on the button operation (e.g., operation of the scan setting button 161 or the scan execution button 162) operated on the main screen of the vendor application 137.

### (Operation of Function Providing Application: When Scan Setting Button and Scan Execution Button are Collectively Displayed on Main Screen of Vendor Application)

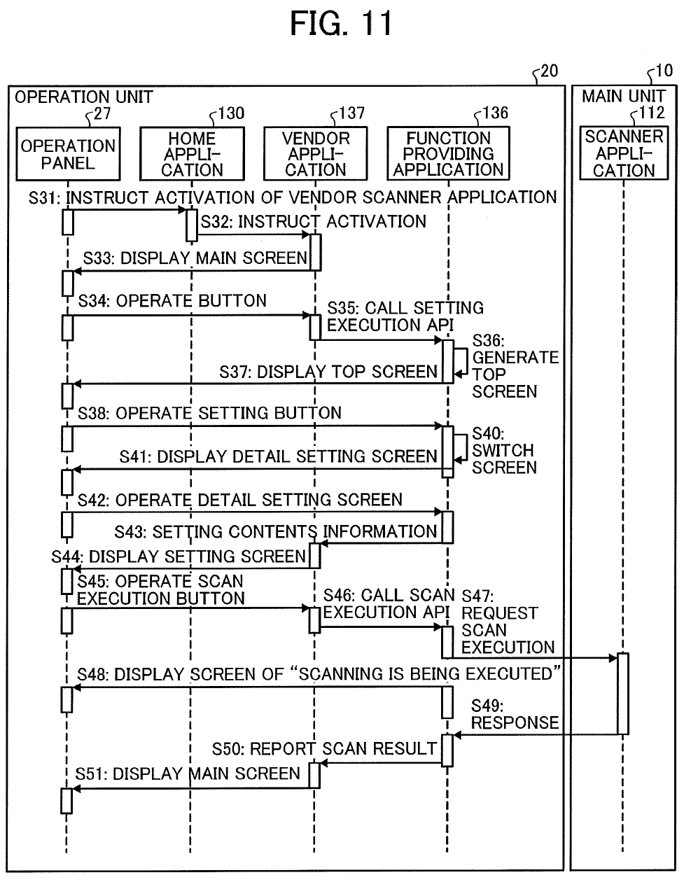

In the above example case described with reference to FIGS. 5 to 10, the operation of the function providing application 136 is described for the case that the scan setting button 161 and the scan execution button 162 are separately displayed on the main screen of the vendor application (see FIG. 7). By contrast, in another example case, the scan setting button 161 and the scan execution button 162 can be displayed collectively on the main screen of the vendor application to be described below, in which a sequential chart illustrated in FIG. 11 is performed. FIG. 11 is another example of a sequential chart illustrating a sequence of an operation of the function providing application 136 when a scan setting button and a scan execution button are displayed collectively.

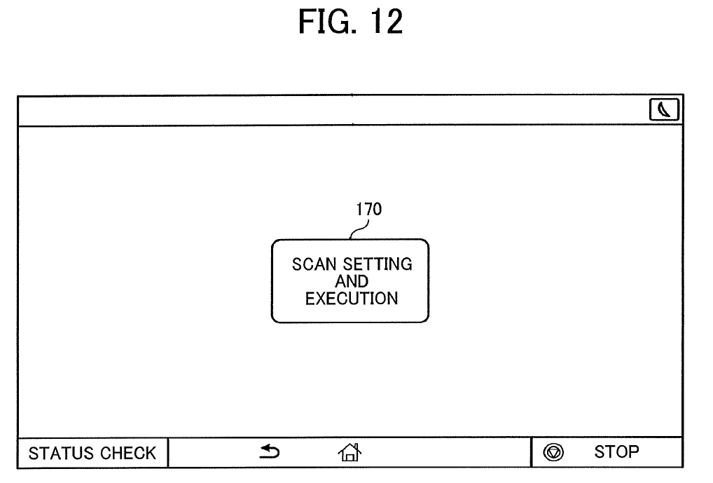

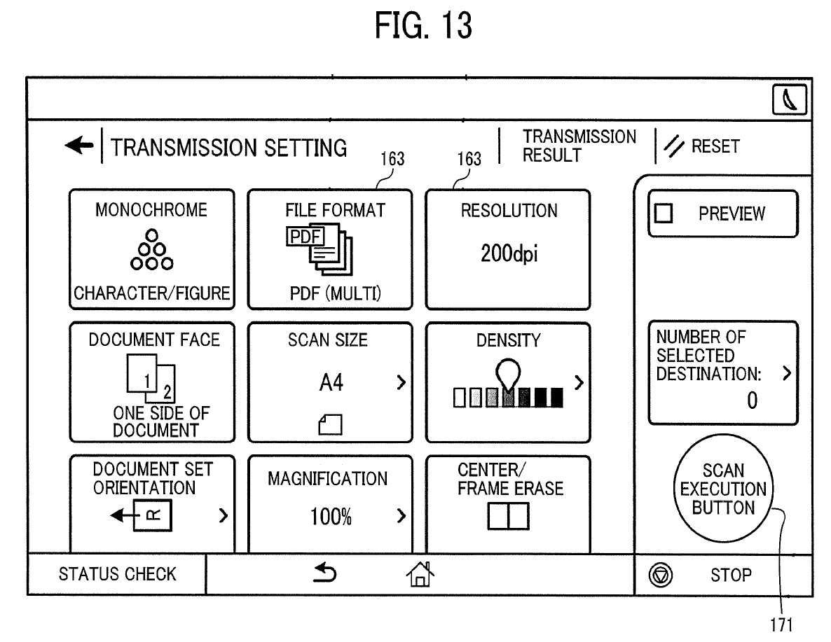

Specifically, when a user operates an icon for instructing an activation of the vendor application 137, an instruction signal instructing the activation of the vendor application 137 is transmitted to the home application 130 from the operation panel 27 (step S31). At step S32, the home application 130 transmits the instruction signal instructing the activation of the vendor application 137 to the vendor application 137. When the vendor application 137 receives the instruction signal instructing the activation of the vendor application 137, the vendor application 137 displays a main screen of the vendor application 137 illustrated in FIG. 12 on the operation panel 27 at step S33. Similar to the above described example case (see FIG. 7), the main screen illustrated in FIG. 12 is an example of a screen when the vendor application 137 is an application that controls a scanner. As illustrated in FIG. 12, the vendor application 137 displays a scan setting and execution button 170 on the main screen, wherein the scan setting and execution button 170 integrates a scan setting button that is operated when instructing the scan setting, and a scan execution button that is operated when instructing the scan execution as one button.

When the scan setting operation or the scan execution operation is to be performed, the user operates the scan setting and execution button 170 (FIG. 12) displayed on the main screen. When the user operates the scan setting and execution button 170, a signal indicating that the scan setting and execution button 170 is operated is transmitted from the operation panel 27 to the vendor application 137 (step S34). When the vendor application 137 receives the signal indicating that the scan setting and execution button 170 is operated, at step S35, the vendor application 137 makes a call of a setting execution API to the function providing application 136, in which the call is used for requesting a display of a top screen used for designating the scan setting operation and the scan execution operation.

When the setting execution API is called, the display control unit 156 of the function providing application 136 generates, for example, a top screen including the various icons 163 associated to various types of the setting items related to the scan operation, and a scan execution button 171 to be operated when designating the scan execution as illustrated in FIG. 13 (step S36). Then, the display control unit 156 of the function providing application 136 performs a display control of the generated top screen on the operation panel 27 at step S37. In an example case of FIG. 13, the display control unit 156 of the function providing application 136 generates the top screen including the various icons 163 associated to various types of the setting items related to the scan operation, and the scan execution button 171 used for instructing the scan execution as illustrated in FIG. 13.

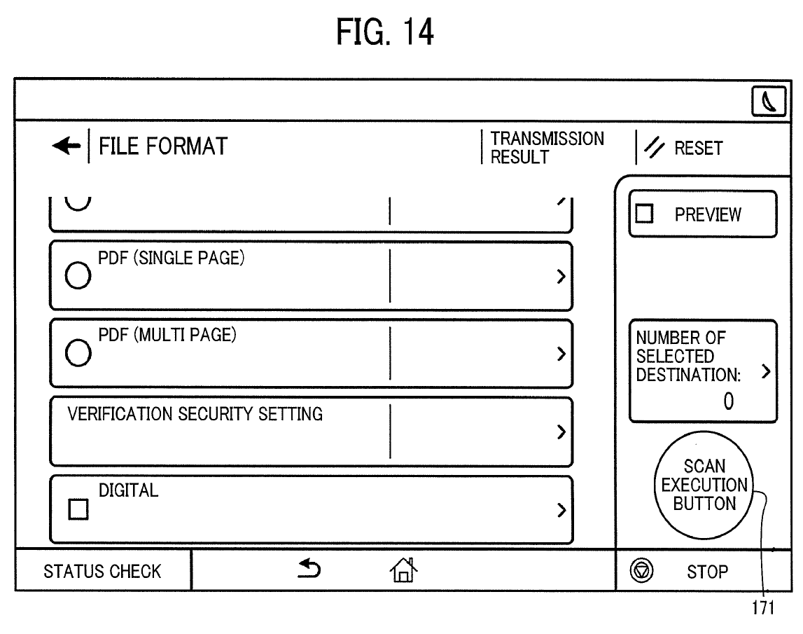

When the various icons 163 associated to various types of the setting items are displayed on the top screen, and then one of the icon 163 associated to a specific setting item is operated by a user, at step S38, a signal indicating that the specific setting item is operated by the user is transmitted from the operation panel 27 to the function providing application 136 as illustrated in FIG. 11. At step S40, the switching unit 153 of the function providing application 136 generates a detail setting screen corresponding to the specific setting item operated by the user. Then, the display control unit 156 of the function providing application 136 displays the detail setting screen on the operation panel 27 at step S41. With this configuration, the screen displayed on the operation panel 27 is switched from the above described top screen to the detail setting screen corresponding to the specific setting item operated by the user. FIG. 14 is an example of the detail setting screen corresponding to the specific setting item operated by the user, in which the file format icon 163 is operated by the user. In an example case of FIG. 14, the display control unit 156 of the function providing application 136 displays the detail setting screen displaying detail icons of the specific setting item with the scan execution button 171 to be operated when executing the scan operation.

When the user performs a detailed setting operation based on the detail setting screen corresponding to the specific setting item (step S42), setting contents information is reported to the vendor application 137 (step S43). When the setting contents information is reported to the vendor application 137, the vendor application 137 updates the setting contents information stored in the above described storage unit such as the RAM 23 and/or the flash memory 24. Further, after the setting contents information is stored, the vendor application 137 displays the top screen (FIG. 13) on the operation panel 27 at step S44.

Further, when the scan execution operation is performed, the user operates the scan execution button 171 displayed on the main screen illustrated in FIG. 13, or the scan execution button 171 displayed on the detail setting screen illustrated in FIG. 14. When the user operates the scan execution button 171, a signal indicating that the scan execution button 171 is operated is transmitted from the operation panel 27 to the vendor application 137 (step S45). When the vendor application 137 receives the signal indicating that the scan execution button 171 is operated, at step S46, the vendor application 137 makes a call of a scan execution API to the function providing application 136. Further, when the vendor application 137 receives the signal indicating that the scan execution button 171 is operated, the vendor application 137 reads out the above described setting contents information from the storage unit, and transmits the above described read setting contents information to the function providing application 136. At step S47, the transmission unit 154 of the function providing application 136 transmits the setting contents information and the scan execution request to the scanner application 112 of the main unit 10. The scanner application 112 of the main unit 10 controls the scan function of the engine 17 based on the setting contents information. With this configuration, the scanner application 112 of the main unit 10 performs an actual scan operation.

Further, similar to the above described one example case (see FIGS. 5 to 10), it can be configured that the setting contents information input by the user via the operation panel 27 is stored in the above described storage unit by the storage control unit 152 of the function providing application 136, in which when the vendor application 137 makes a call of the scan execution API, the storage control unit 152 of the function providing application 136 reads out the setting contents information from the storage unit, and transmits the setting contents information to the scanner application 112.

The display control unit 156 of the function providing application 136 generates a screen displaying that the scanning is being executed (see FIG. 10) corresponding to the scan operation being executed by the scanner application 112 of the main unit 10, and displays the screen displaying that the scanning is being executed on the operation panel 27 at step S48.

Then, when the scan execution operation is completed, the scanner application 112 of the main unit 10 issues the job ID as described above, and transmits the job ID to the function providing application 136 as a response to the scan execution request at step S49. Further, instead of the job ID, the image information acquired by the scan execution operation can be transmitted from the scanner application 112 to the function providing application 136 as a response to the scan execution request as above described with reference to FIGS. 5 to 10.

When the transmission unit 154 of the function providing application 136 receives the job ID, at step S50, the transmission unit 154 reports the job ID to the vendor application 137 as a scan result. The vendor application 137 stores the reported job ID in the storage unit such as the flash memory 24 and/or the RAM 23. After storing the job ID, at step S51, the vendor application 137 performs a display control of the main screen illustrated in FIG. 12 on the operation panel 27. As above described, when the scan setting and execution button 170 displayed on the main screen of the vendor application 137 is operated, the display control unit 156 of the function providing application 136 displays the top screen illustrated in FIG. 13, and performs the above described scan setting operation or the scan execution operation.

### (Customization of Setting Screen)

A description is given of customization of each of the setting items described in FIG. 8 or FIG. 13 by the vendor application 137, in which the vendor application 137 can designate “enable/disable,” “visible/invisible” and “display sequence” for each of the setting items. Specifically, for example, when the setting items are scan setting items, the vendor application 137 can designate whether each of the setting items such as color print, monochrome print, resolution, and scan size is to be displayed or not, and can designate a display sequence of each of the setting items such as color print, monochrome print, resolution, and scan size. The display control unit 156 of the function providing application 136 displays each of the setting items with a display style designated by the vendor application 137.

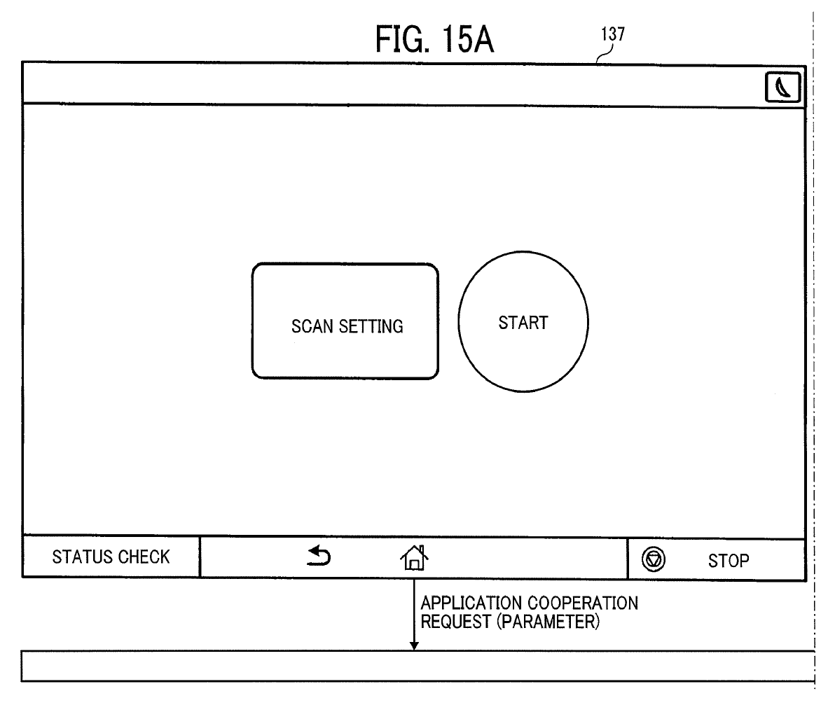

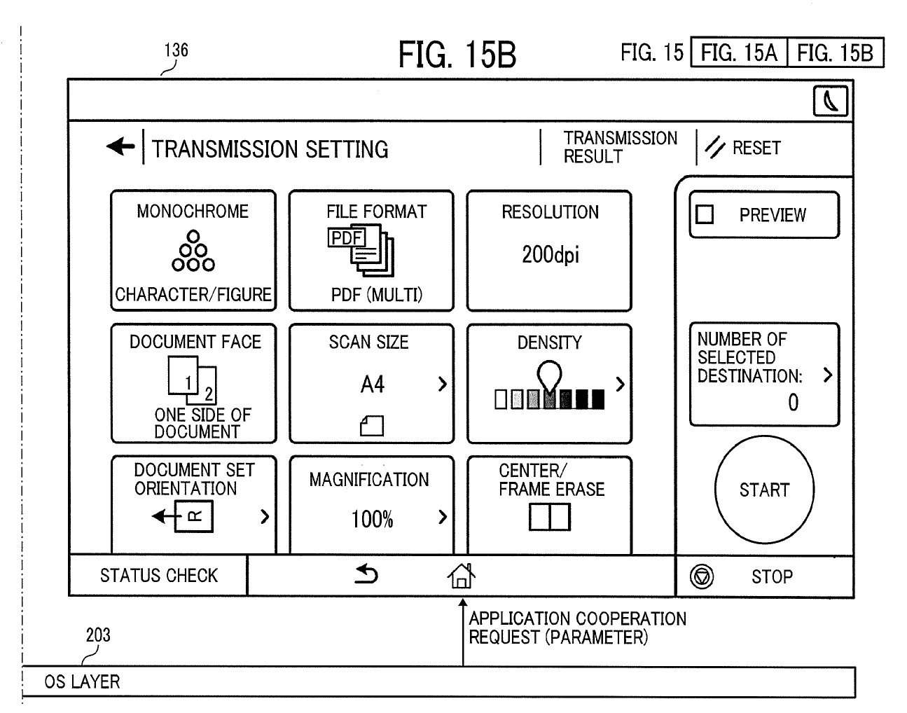

A description is given of an example case. For the simplicity of description, at steps S5 and S15 in the sequential chart of FIG. 5, and at steps S35 and S46 in the sequential chart of FIG. 11, it is assumed that the vendor application 137 requests the function providing application 136 directly. However, in the MIT 1 of the embodiment, as illustrated in FIGS. 15A and 15B, the communication between the vendor application 137 and the function providing application 136 is intermediated by the OS layer 203 of the operation unit 20.

The function providing application 136 is registered in the OS layer 203 in advance as an application that can receive an “application cooperation request,” in which the application is designated in advance and registered. When the OS layer 203 receives the “application cooperation request” from the vendor application 137, the OS layer 203 reports the “application cooperation request” to the function providing application 136 designated and registered in advance. For example, when a plurality of the function providing applications 136 such as an application providing a copy function and an application providing a scanner function are designated and registered in advance, the OS layer 203 reports the “application cooperation request” to each one of the applications.

When the application cooperation request is performed, the vendor application 137 designates some parameters. The vendor application 137 designates “a specific processing requested to the function providing application 136” and “setting items to be displayed on a setting screen” by using the parameters. Table 1 is an example of a list of parameters used for the application cooperation request.

TABLE 1

| Parameter | Value | Description |
|---|---|---|
| Action | scan_setting | Scan setting |
| | scan_job | Scan execution |
| | etc | etc |
| Setting_ScanColor | Visible | Display color setting |
| | Invisible | Not display color setting |
| Setting_FileFormat | Visible | Display file format setting |
| | Invisible | Not display file format setting |
| Setting_Resolution | Visible | Display resolution setting |
| | Invisible | Not display resolutin setting |
| Setting_OriginalSize | Visible | Display scan size setting |
| | Invisible | Not display scan size setting |
| Setting_Density | Visible | Display density setting |
| | Invisible | Not display density setting |
| Setting_Magnification | Visible | Display magnification setting |
| | Invisible | Not display magnification setting |
| . . . | . . . | . . . |

In Table 1, the parameter “Action” is used to set an operation to be requested to the function providing application 136. For example, when a display of a scan setting screen is requested, the vendor application 137 sets the parameter “Action” with a value of “scan_setting (indicating setting of scan)” and requests the display of the scan setting screen to the function providing application 136. Further, when the scan execution is requested, the vendor application 137 sets the parameter “Action” with a value of “scan_job (indicating execution of scan),” and requests the scan execution to the function providing application 136.

As illustrated in Table 1, each of the parameters such as “Setting_ScanColor (indicating color setting item),” “Setting_FileFormat (indicating file format setting item),” “Setting_Resolution (indicating resolution setting item),” “Setting_Original Size (indicating scan size setting item),” “Setting_Density (indicating density setting item)” and “Setting_Magnification (indicating magnification setting item)” can be set with a value of “Visible/Invisible.” When each of the setting items is to be displayed, “Visible” is sets as a value. Further, when each of the setting items is not be displayed, “Invisible” is set as a value. When the reception unit 151 of the function providing application 136 receives these parameters via the OS layer 203, the function providing application 136 performs processing corresponding to the received parameter.

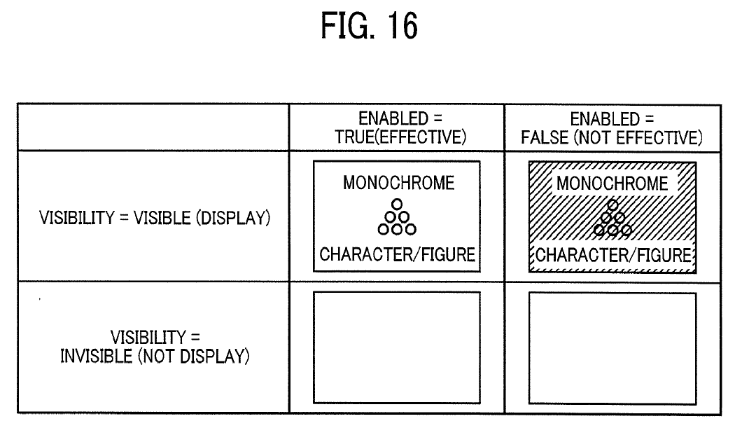

Further, the function providing application 136 can designate “enable/disable” for a user-initiating setting operation as illustrated in FIG. 16. FIG. 16 is an example of a display style of the color setting item when the user-initiating setting operation to the color setting item is designated with “enable,” and a display style of the color setting item when the user-initiating setting operation to the color setting item is designated with “disable (prohibited or not allowed).” In an example case of FIG. 16, when the color setting item is set with “Invisible (Not display),” the display control unit 156 of the function providing application 136 does not display the color setting item on the scan setting screen even if the user-initiating setting operation designates any one of “enable” and “disable.”

By contrast, when the color setting item is set with “Visible (Display),” and the user-initiating setting operation for the color setting item is set with “enable,” the display control unit 156 of the function providing application 136 displays the color setting item with a standard illuminance and standard transparency on the scan setting screen as illustrated in FIG. 16. By contrast, when the color setting item is set with “Visible (Display),”, and the user-initiating setting operation for the color setting item is set with “disable,” the display control unit 156 of the function providing application 136 displays the color setting item with illuminance lower than standard illuminance and transparency higher than standard transparency (e.g., semitransparent transparency) on the scan setting screen as illustrated in FIG. 16, which is a semitransparent display indicated by slashed lines. When the color setting item is displayed with the standard illuminance and standard transparency, the user can recognize visually that the color setting item can be set any information. Further, when the color setting item is displayed with the semitransparent, the user can recognize visually that the color setting item cannot be operated.

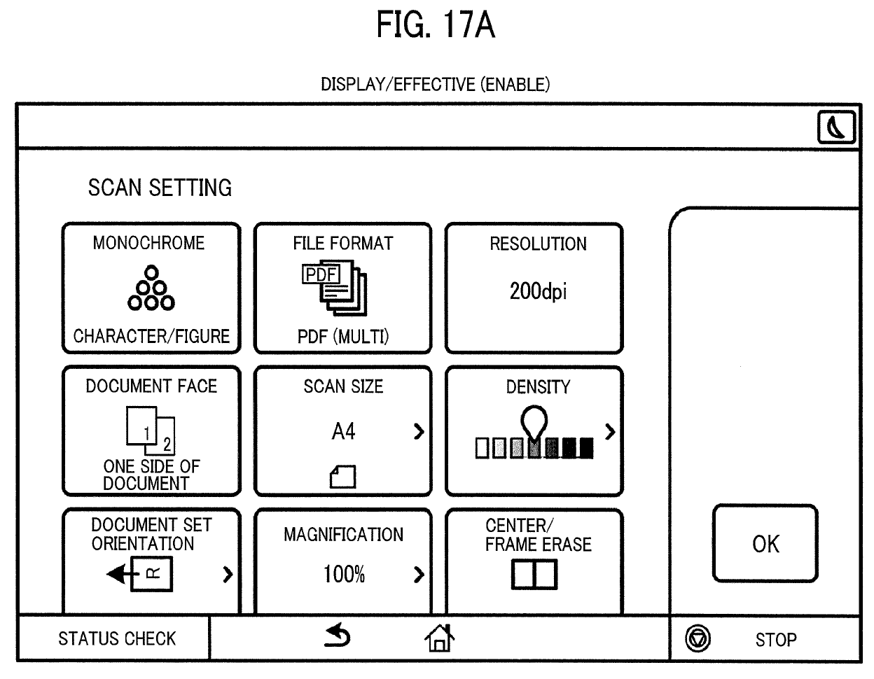

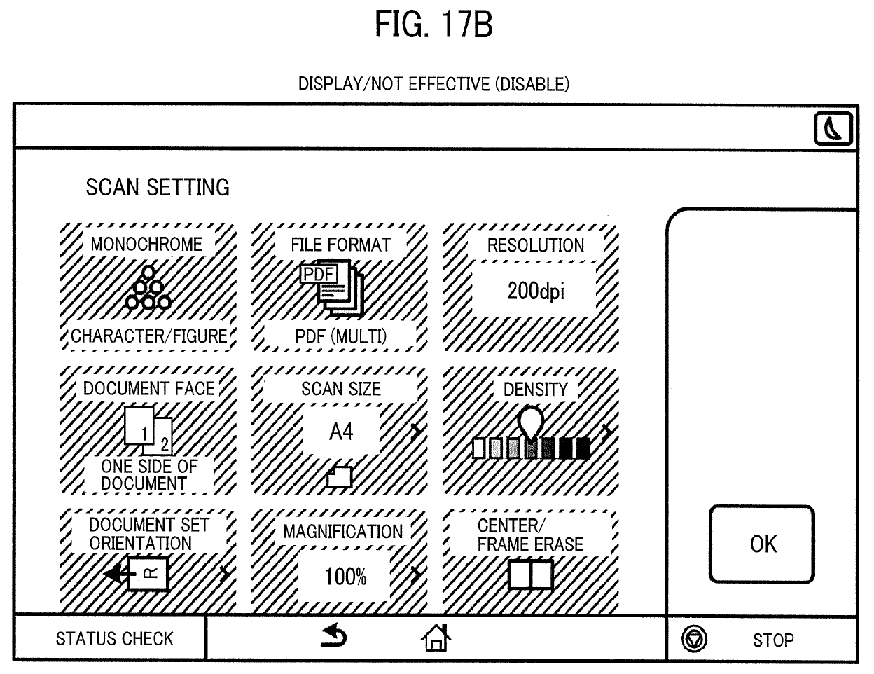

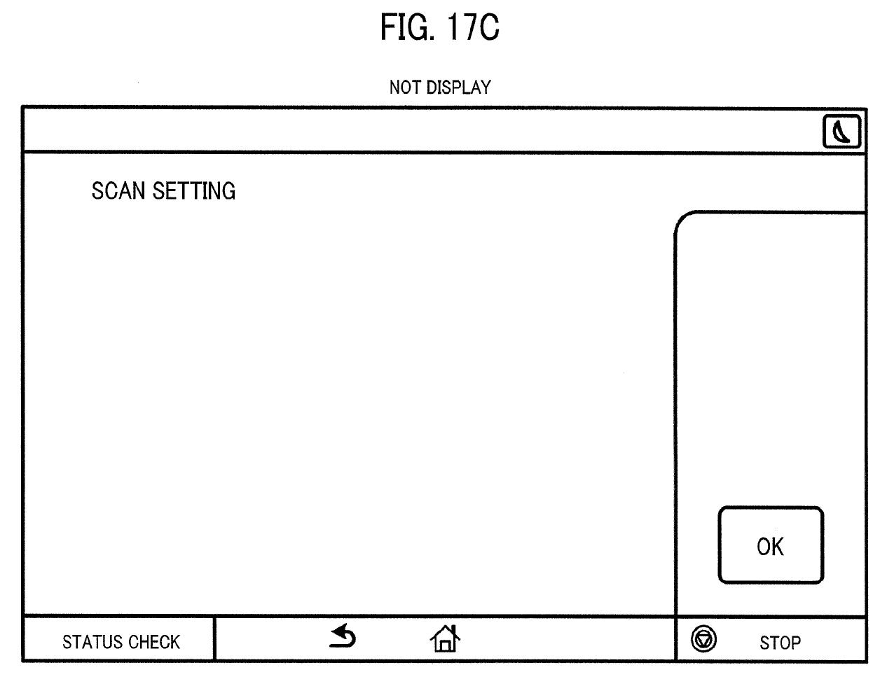

Further, the “enable/disable” settable for the user-initiating setting operation can be set for each one of the setting items one by one, or can be set for all of the setting items collectively. Specifically, for example, when a display of all of the setting items on the scan setting screen is designated by the vendor application 137, and “enable” is set for all of the setting items for the user-initiating setting operation by the setting processing unit 155 of the function providing application 136, the display control unit 156 of the function providing application 136 displays all of the setting items on the scan setting screen with the standard illuminance and standard transparency as illustrated in FIG. 17A.

By contrast, when a display of all of the setting items on the scan setting screen are designated by the vendor application 137, and “disable” is set for all of the setting items for the user-initiating setting operation by the setting processing unit 155 of the function providing application 136, the display control unit 156 of the function providing application 136 displays all of the setting items on the scan setting screen with the illuminance lower than standard illuminance and transparency higher than standard transparency as illustrated in FIG. 17B indicated by slashed lines. Further, when all of the setting items on the scan setting screen are designated as “Invisible” by the vendor application 137, the display control unit 156 of the function providing application 136 does not display all of the setting items on the scan setting screen as illustrated in FIG. 17C.

Table 2 is an example of a list of parameters set with values, in which “Setting_OriginalSize (indicating scan size setting item)” is set with “Invisible” on the scan setting screen (scan_setting).

TABLE 2

| Parameter | Value |
|---|---|
| Action | scan_setting |
| Setting_ScanColor | Visible |
| Setting_FileFormat | Visible |
| Setting_Resolution | Visible |
| Setting_OriginalSize | Invisible |
| Setting_Density | Visible |
| Setting_Magnification | Visible |

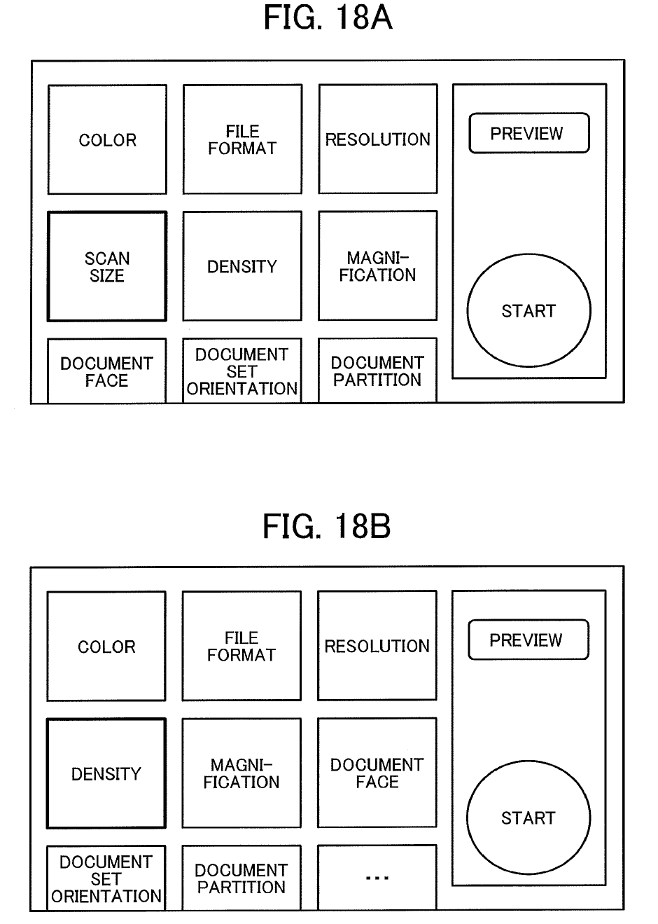

FIG. 18A is an example of a scan setting screen that displays the scan size setting item. By contrast, when the scan size setting item is set with “Invisible” as illustrated in Table 2, the display control unit 156 of the function providing application 136 does not display the scan size setting item on the scan setting screen as illustrated in FIG. 18B. Specifically, when one parameter (first parameter) of one setting item is set with “Invisible,” the display control unit 156 of the function providing application 136 displays another parameter (second parameter subsequent after the first parameter) of another setting item set with “Visible” by shifting another parameter to a display position where the one parameter, set currently with “Invisible,” was displayed when the one parameter item was set with “Visible.” In an example case of FIG. 18B, the display control unit 156 of the function providing application 136 displays the “density” setting item at a display position where the scan size setting item, set currently with “Invisible,” was displayed when the scan size setting item was set with “Visible.”

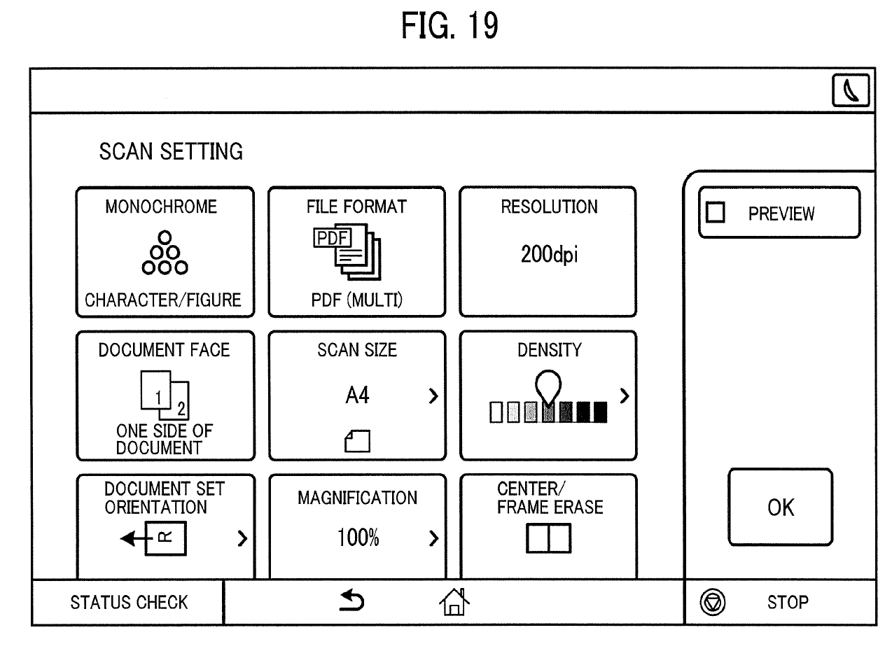

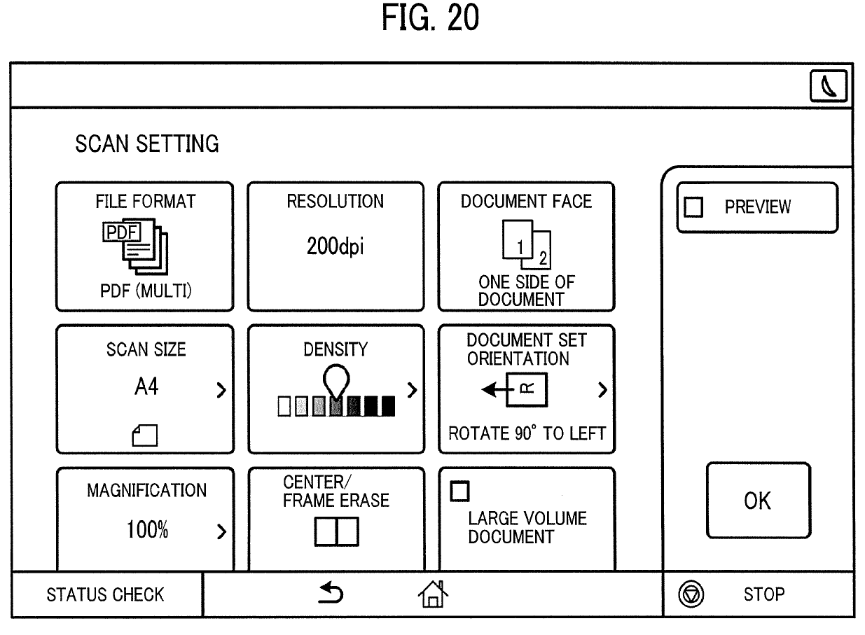

Similarly, FIG. 19 is an example of a standard display style of the setting screen of the function providing application 136, in which the scan setting screen displays all of the setting items. Then, when the color setting item such as an icon having black/white, character, and figure is set with “Invisible” by the vendor application 137, the function providing application 136 does not display the color setting item as illustrated in FIG. 20, and the display control unit 156 of the function providing application 136 displays the file format setting item, subsequent after the color setting item, at a display position where the color setting item was displayed (FIG. 19) by shifting the file format setting item.

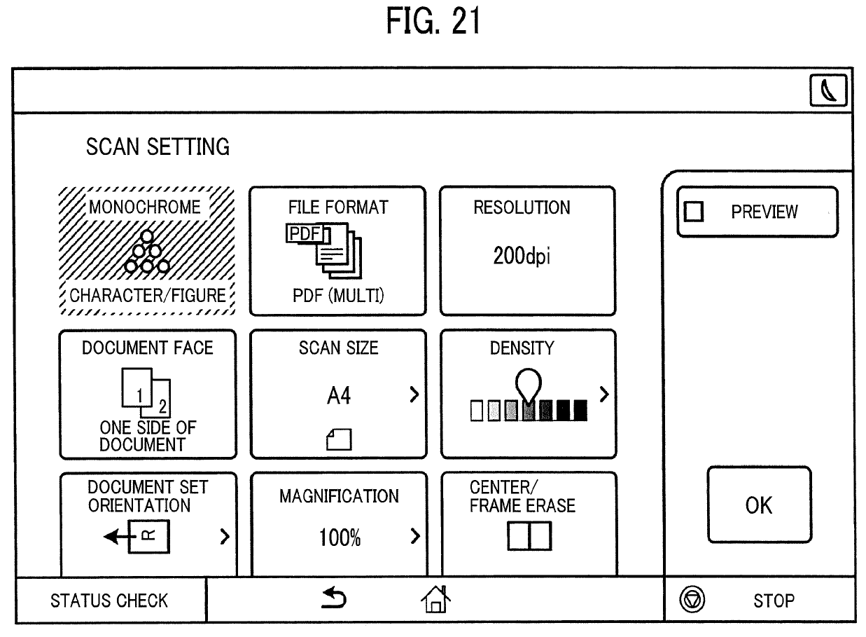

Further, when the setting of the color setting item by the user-initiating setting operation user is set to “disable,” the display control unit 156 of the function providing application 136 displays the designated color setting item with semitransparent as illustrated in FIG. 21 indicated by slashed lines.

Table 3 is an example of a list of arrangement of each of the setting items (parameters) when a display position of “Setting_ScanColor (indicating color setting item)” and a display position of “Setting_FileFormat (indicating file format setting item)” are exchanged on the scan setting screen (scan_setting).

TABLE 3

| Parameter | Value |
|---|---|
| Action | scan_setting |
| Setting_ScanColor | Visible |
| Setting_FileFormat | Visible |
| Setting_Resolution | Visible |
| Setting_Original Size | Visible |
| Setting_Density | Visible |
| Setting_Magnification | Visible |

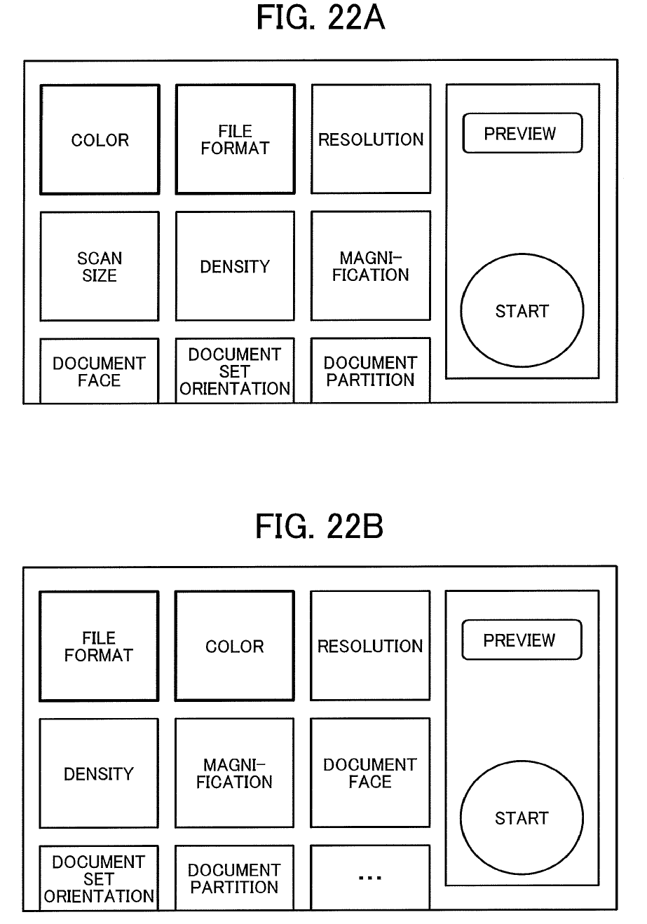

FIG. 22A is an example of a standard arrangement of each of the setting items on the scan_setting screen. When the standard arrangement is used, the display control unit 156 of the function providing application 136 displays the file format setting item after the color setting item. However, as illustrated in Table 2, when the color setting item and the file format setting item are exchanged with each other, the display control unit 156 of the function providing application 136 displays the file format setting item at first, and then displays the color setting item after the file format setting item as illustrated in FIG. 22B.

### (Operation Provided by Selected Function)

A description is given of a case when the operation unit 20 stores a plurality of applications having different user interfaces (UIs) for the same function. For example, the first copy reception application 131 and the second copy reception application 132 illustrated in FIG. 3 are used for the same copy function. In this case, the first copy reception application 131 receives a user's copy operation via a first set of operation buttons and setting buttons. Further, the second copy reception application 132 is used as an application to display a second set of operation buttons and setting buttons. The second set of operation buttons and setting button used with higher frequency reduces the number of the displayed operation buttons and setting buttons compared to the first set of operation buttons and setting buttons set for the first copy reception application 131 such that visibility and operability of the displayed operation buttons and setting buttons can be enhanced.

The vendor application 137 may designate a use of an application having reduced the number of functions, or an application having more functions. Further, the vendor application 137 may designate any one of the application having reduced the number of functions and the application having more functions as a to-be-used application. The operation unit 20 can include a plurality of the function providing applications 136 that provide different user interfaces (UIs) although the plurality of the function providing applications 136 provides the same function. Among the plurality of the function providing applications 136, any one of the function providing applications 136 designated by the vendor application 137 or matched to an operation status is activated.

Table 4 is an example of a list of parameters when the function providing application 136 is used as an application for providing the scan function including a plurality of types such as a first type of the function providing application 136, a second type of the function providing application 136, and a third type of the function providing application 136. In Table 4, the parameter “Action” is set for a plurality of types of the function providing application 136 having the same function. For example, the first type of the function providing application 136 is a standard scan type that receives settings via a standard user interface (UI), and performs the scan execution operation. The second type of the function providing application 136 is an easy scan type that receives settings via a standard user interface (UI), and performs the scan execution operation. The third type of the function providing application 136 is a smart scan type that that receives settings via a user interface (UI) having reduced the number of operation buttons and setting buttons (i.e., the operation buttons and setting buttons are used with higher frequency), and performs the scan execution operation.

TABLE 4

| Parameter | Value | Description |
|---|---|---|
| Action | scan_setting | Scan setting |
| | scan_job | Scan execution |
| | . | . |
| | . | . |
| | . | . |
| | easy_scan_ | Scan setting of easy scan |
| | setting | application |
| | easy_scan_ | Scan execution of easy |
| | job | scan application |
| | . | . |
| | . | . |
| | . | . |
| | smart_scan_ | Scan setting of smart scan |
| | setting | application |
| | smart_scan_ | Scan execution of smart |
| | job | scan application |
| | . | . |
| | . | . |
| | . | . |
| Setting_ScanColor | Visible | Display color setting |
| | Invisible | Not display color setting |
| | . | . |
| | . | . |
| | . | . |

As illustrated in Table 4, when the function providing application 136 of the easy scan type and the function providing application 136 of the smart scan type are provided, the parameter “Action” used for setting an operation of the function providing application 136, which is described with reference to Table 1, is added with values of “easy_scan_setting (indicating easy scan_setting),” “easy_scan_job (indicating easy scan execution),” “smart_scan_setting (indicating smart scan_setting),” and “smart_scan_job (indicating smart scan execution).”

Further, when the function providing application 136 for easy copy type and the function providing application 136 for smart copy type are provided, the parameter “Action” is added with values of “easy_copy_setting (indicating easy_copy_setting),” “easy_copy_job (indicating easy copy execution),” “smart_copy_setting (indicating smart copy setting),” and “smart_copy_job (indicating smart copy execution).”

As indicated in Table 4, when a display of the scan setting screen of the easy scan type is instructed to display a display screen of the scan setting operation, the vendor application 137 inputs the value of “easy scan_setting (indicating scan setting)” for the parameter “Action” to designate the scan setting screen of the easy scan type. Further, when a display of the scan setting screen of the smart scan type is instructed to display a display screen of the scan setting operation, the vendor application 137 inputs the value of “smart_scan_setting” for the parameter “Action” to designate the scan_setting screen of the smart scan type.

When the value of the parameter “Action” is any one of “easy_scan_setting” and “smart_scan_setting,” the OS layer 203 of the operation unit 20 reports the value of “easy_scan_setting” to both of the function providing application 136 for easy scan type and the function providing application 136 of the smart scan type. If the received parameter is not related to the function providing application 136 of the easy scan type and the function providing application 136 of the smart scan type, each of the function providing application 136 of the easy scan type and the function providing application 136 of the smart scan type ignores a request instructed by the parameter.

For example, the value of “easy_scan_setting” is used for the function providing application 136 of the easy scan type. Therefore, when the function providing application 136 of the smart scan type receives the value of “easy_scan_setting,” the function providing application 136 of the smart scan type does not display the easy scan setting screen designated by the value of “easy_scan_setting,” which means the function providing application 136 of the smart scan type ignores a request instructed by the parameter. By contrast, when the function providing application 136 of the easy scan type receives the value of “easy_scan_setting” via the reception unit 151, the display control unit 156 of the function providing application 136 of the easy scan type displays the easy_scan_setting screen designated by the value of “easy_scan_setting.”

Further, the scan_setting can be instructed by setting a value of “scan_setting” without explicitly designating “easy” or “smart” for the parameter “Action.” As described above, the value of “scan_setting” is transmitted to both of the function providing application 136 of the easy scan type and the function providing application 136 of the smart scan type.

In this example case, the value of “scan_setting” is not designated with “easy_scan_setting” or “smart_scan_setting.” In this example case, the function providing application 136 of the standard scan type is activated because the function providing application 136 of the standard scan type can provide more operation buttons, setting buttons and functions compared to the function providing application 136 of the easy scan type. Further, when the function providing application 136 of the standard scan type is not installed, the function providing application 136 of the easy scan type is activated. Table 5 is an example of a list of operations for each of value set for the parameter “Action.” Table 5 is an example of a list of operations by the function providing application 136 of the easy scan type and the function providing application 136 of the smart scan type depending on the values.

TABLE 5

| | Operation of easy | Operation of smart |
|---|---|---|
| Value | scan application | scan application |
| easy_scan_setting | Activate setting screen | Ignore |
| smart_scan_setting | Ignore | Activate setting screen |
| scan_setting | Activate setting screen | Ignore |
| | when standard scan | |
| | application is not installed | |

### (Operation for Plurality of Vendor Applications)

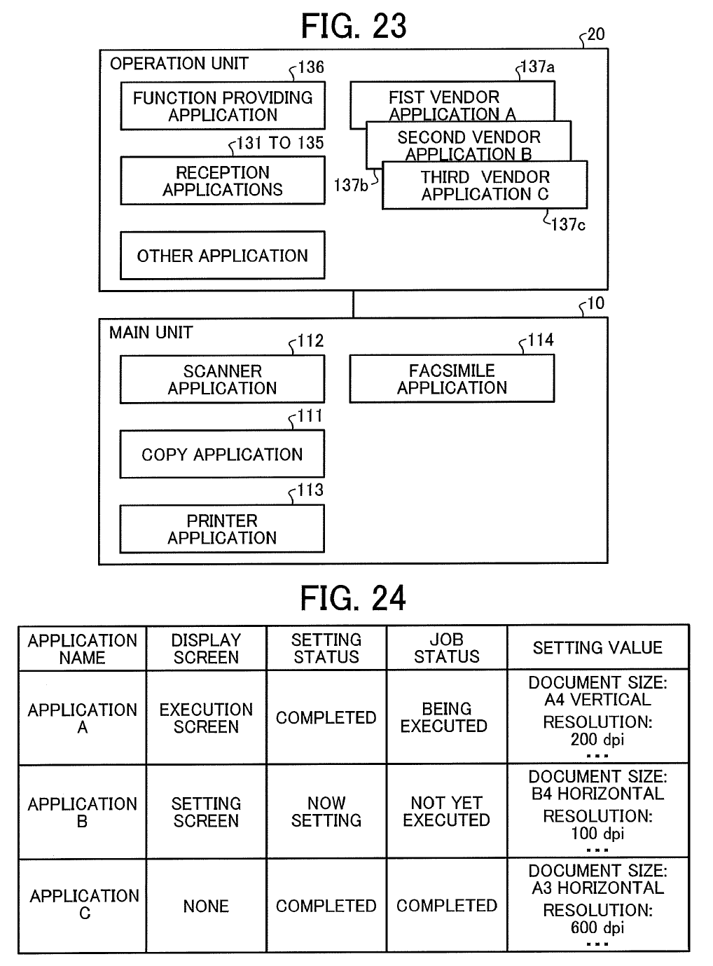

A description is given of an example configuration when a plurality of the vendor applications 137 such as vendor applications 137a to 137c are stored in the operation unit 20 as illustrated in FIG. 23. In this configuration, the storage control unit 152 of the function providing application 136 (FIG. 4) stores “application data” of each one of the vendor applications 137a to 137c such as a request contents, setting values and status information of each one of the vendor applications 137a to 137c in the storage unit such as the RAM 23 and/or the flash memory 24. Further, when the storage control unit 152 receives a request from the vendor application 137, the storage control unit 152 reads out information of the vendor application 137, which has transmitted the request, from the above described storage unit. Then, the display control unit 156 performs a display control and a job execution control based on the information of the vendor application 137 read out from the storage unit, in which the vendor application 137 has transmitted the request. Further, when the storage control unit 152 receives one job request, the switching unit 153 switches display contents based on an execution status of another job.

FIG. 24 is an example of “application data” stored in the storage unit such as the RAM 23 and/or the flash memory 24 by the storage control unit 152 of the function providing application 136, in which the storage unit used as the secondary memory is used as status information storage unit. As illustrated in FIG. 24, the storage control unit 152 stores an application name, a display screen status, a setting status, a job status, and setting values of each of the vendor applications 137 by associating the application name, the display screen status, the setting status, the job status, and the setting values in the above described storage unit.

Specifically, in an example case of FIG. 24, the display screen status, the setting status, the job status, and the scan setting values are associated for each of the vendor applications 137a (first vendor application A), 137b (second application B), and 137c (third vendor application C). In an example case of FIG. 24, the scanning is used as an example of jobs. For example, as to the vendor application 137a (first vendor application A), the display screen status indicates a screen displaying an scan operation is being executed currently (see FIG. 10), the setting status indicates information that the scan setting has completed, the job status indicates information that a scan job is being executed, and the scan setting value indicates information that “document size is A4 vertical, and resolution is 200 dot per inch (dpi).” Similarly, as to the vendor application 137b (second vendor application B), the display screen status indicates that a screen displaying a scan setting screen currently (see FIG. 8, FIG. 9), the setting status indicates information that the scan setting is being set, the job status indicates information that a scan job is not yet executed, and the scan setting value indicates information that “document size is B4 horizontal, and resolution is 100 dpi.”

Similarly, as to the vendor application 137c (third application C), the display screen status indicates that a screen is not displayed currently, the setting status indicates information that the scan setting has completed, the job status indicates information that a scan job has ended, and the scan setting value indicates information that “document size is A3 horizontal, and resolution is 600 dpi.” In this configuration, the function providing application 136 performs operations corresponding to the status of each of the vendor applications 137.

(Operation when a Setting Request is Performed when a Plurality of Vendor Applications is Stored)

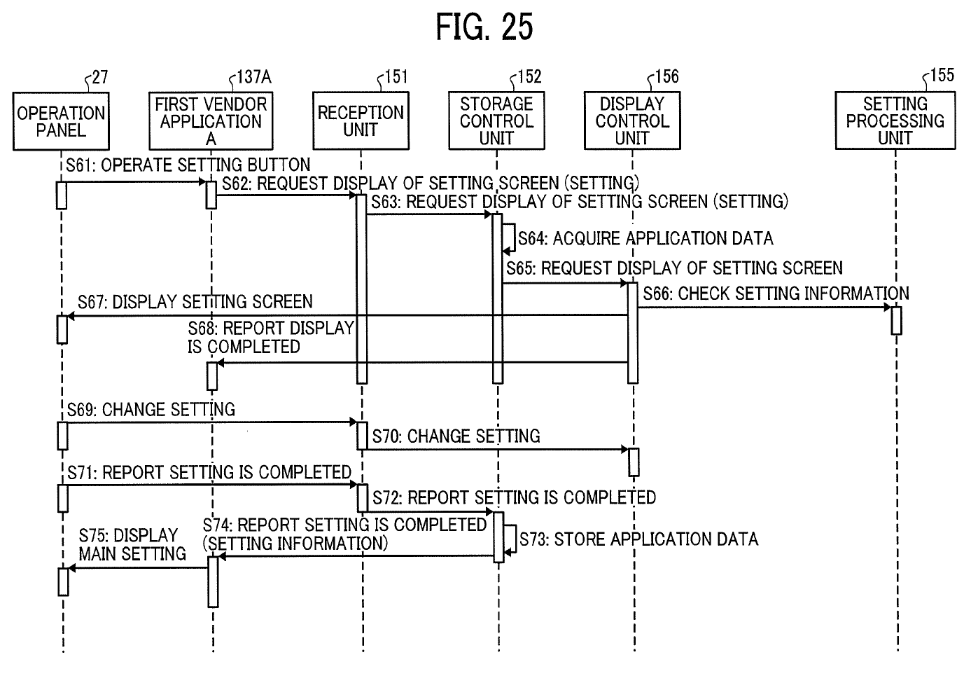

FIG. 25 is an example of a sequential chart illustrating a sequence of an operation by the function providing application 136 when, for example, the vendor applications 137a to 137c (first vendor application A to third vendor application C) are stored in the operation unit 20, in which the function providing application 136 displays a setting screen requested by the first vendor application A based on a setting status and a job execution status of each one the first vendor application A to the third vendor application C.

At first, when a user operates the operation panel 27 to instruct a display of a setting screen of the first vendor application A (step S61), the first vendor application A transmits a display request of the setting screen to the function providing application 136. In the function providing application 136, the reception unit 151 receives the display request of the setting screen (step S62), and transmits the display request of the setting screen to the storage control unit 152 (step S63). The storage control unit 152 reads out application data corresponding to the first vendor application A from the “application data” stored in the storage unit such as the RAM 23 and/or the flash memory 24 (step S64).

When it is determined that no display screen is displayed for the first vendor application A currently, and the setting is not yet completed based on the read application data of the first vendor application A, the storage control unit 152 transmits the display request of the setting screen to the display control unit 156 (step S65). The display control unit 156 performs a checking of setting information to the setting processing unit 155 (step S66), and then the display control unit 156 generates and displays the setting screen on the operation panel 27 based on the reported information, and specification information of the MFP 1 retained by the setting processing unit 155 (step S67). Further, when the setting screen is displayed, the display control unit 156 transmits a display report to the first vendor application A that the display of the setting screen is completed (step S68).

By contrast, when it is determined that the setting screen for the first vendor application A is being displayed currently based on the read application data of the first vendor application A, the display control unit 156 checks currently-set setting information to the setting processing unit 155, and generates a setting screen, and displays the setting screen on the operation panel 27 based on the checked current-set setting information.

Further, when the user has changed the setting information on the displayed setting screen, a change instruction of setting information input by the user is received by the reception unit 151 of the function providing application 136 (step S69), and then transmitted to the display control unit 156 (step S70). The display control unit 156 displays a new setting screen, updated based on the changed setting information, on the operation panel 27.

Further, when the setting operation is completed, the user performs a setting completion operation via the operation panel 27. The reception unit 151 of the function providing application 136 receives a setting completion signal from the operation panel 27 (step S71), and transmits the setting completion signal to the storage control unit 152 (step S72). When the storage control unit 152 receives the setting completion signal, the storage control unit 152 updates the application data of the first vendor application A based on the setting information updated and input by the user (step S73) among the “application data” stored in the above described storage unit. Then, the storage control unit 152 transmits the setting information to the first vendor application A, and transmits a setting completion report (step S74). When the first vendor application A receives the setting completion report, the first vendor application A recognizes that the setting operation is completed, and displays, for example, the main screen (FIG. 7 or FIG. 12) on the operation panel 27 (step S75).

(Job Execution Operation when a Plurality of Vendor Applications is Stored)

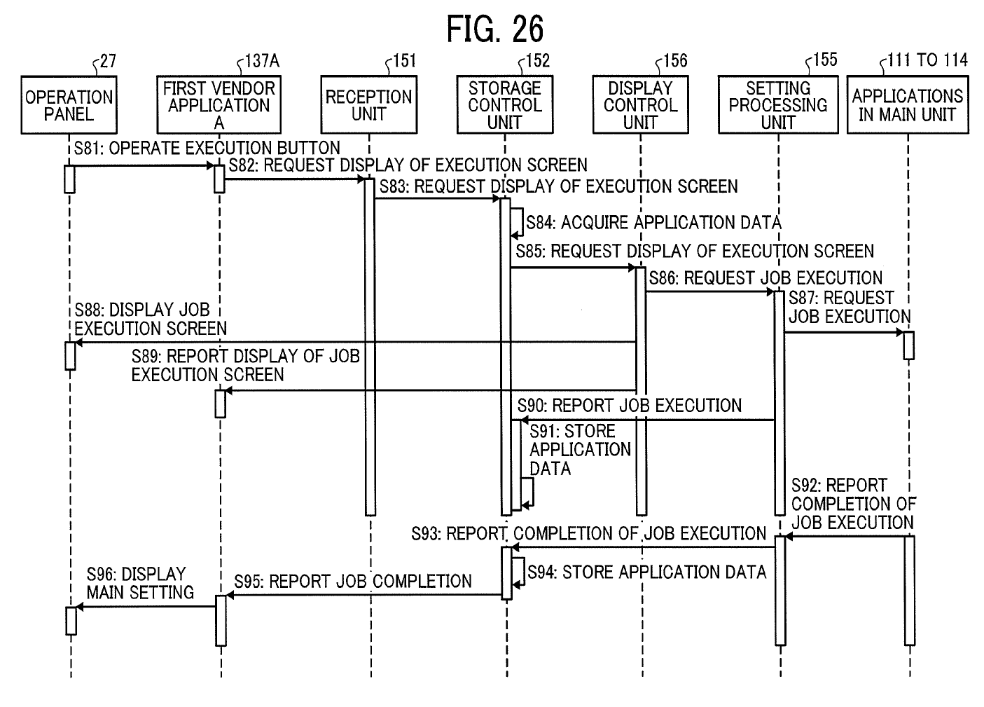

FIG. 26 is an example of a sequential chart illustrating a sequence of an operation by the function providing application 136 when, for example, the vendor applications 137a to 137c (first vendor application A to third vendor application C) are stored in the operation unit 20, in which the function providing application 136 executes a job requested by the first vendor application A based on a display status and a job execution status of each one of the first vendor application A to the third vendor application C.

At first, when a user operates the operation panel 27 to instruct a job execution of the first vendor application A (step S81), the first vendor application A transmits a display request of a job execution screen to the function providing application 136. In the function providing application 136, the reception unit 151 receives the display request of the job execution screen (step S82), and transmits the display request of the job execution screen to the storage control unit 152 (step S83). The storage control unit 152 reads out the application data corresponding to the first vendor application A from the “application data” stored in the storage unit such as the RAM 23 and/or the flash memory 24 (step S84).

When it is determined that no display screen is displayed for the first vendor application A currently, and the setting is completed based on the read application data of the first vendor application A, the storage control unit 152 transmits the display request of the job execution screen to the display control unit 156 (step S85). When the display control unit 156 receives the display request of the job execution screen, the display control unit 156 transmits a job execution request to the setting processing unit 155 (step S86). The setting processing unit 155 transmits the job execution request to the application of the main unit 10 (step S87).

Further, when the display control unit 156 transmits the job execution request to the setting processing unit 155 (step S86), at step S88, the display control unit 156 displays the job execution screen on the operation panel 27, and at step S89, the display control unit 156 transmits a display report of the job execution screen to the first vendor application A. Further, when the storage control unit 152 receives a job execution report from the setting processing unit 155 (step S90), the first vendor application A stores the application data indicating that a job is being executed currently in the above described storage unit (step S91).

When the setting processing unit 155 receives a job completion report indicating that the job is executed and completed from the application of the main unit 10 (step S92), the setting processing unit 155 transmits the received job completion report to the storage control unit 152 (step S93). The storage control unit 152 stores the application data indicating that the job of the first vendor application A has completed in the above described storage unit (step S94). Further, the storage control unit 152 transmits the job completion report to the first vendor application A (step S95). When the first vendor application A receives the job completion report, the first vendor application A displays, for example, the main screen (see FIG. 7, FIG. 12) on the operation panel 27 (step S96).

As above described, the function providing application 136 performs the display control of the setting screen and the job execution control based on the setting status and the job execution status of each of the first vendor application A to the third vendor application C. With this configuration, even if a plurality of applications is stored in the operation unit 20, each of the applications can be performed by recognizing the setting status and the job execution status of each of the applications.

(Display of Message when Main Unit is Executing Job)

A description is given of a case when the main unit 10 cannot receive a plurality of jobs at the same time when the main unit 10 is executing a job of one application currently. The storage control unit 152 of the function providing application 136 refers the application data of each of the first vendor application A to the third vendor application C (vendor applications 137a to 137c) stored in the storage unit to check the job execution status of each of the first vendor application A to the third vendor application C. Then, when the storage control unit 152 detects that the main unit 10 is executing a job of a vendor application A, the display control unit 156 displays a message that a job cannot be executed for a second vendor application B such as “job cannot be executed currently” on the operation panel 27 as a report operation. In this example case, the status that the job cannot be executed is reported to the user by displaying the message, but not limited thereto. For example, the status that the job cannot be executed can be reported to the user by using a light emission control and/or a sound output control.

With this configuration, the user can recognize that a job cannot be executed currently before the user inputs the job execution request to the main unit 10, in which an unnecessary request is not input to the main unit 10, and thereby the processing load of the main unit 10 can be reduced.

(When One Job is being Executed)

Further, a description is given of a case when a longer time is required for the main unit 10 to complete a being-executed job. In this case, when a user performs a setting operation of a second job such as the scan setting or copy setting while the main unit 10 is executing a first job, the user has to wait for some time to execute the second job until the main unit 10 completes the execution of the first job. For example, when a second user U2 sets setting values for the second job while waiting a completion of the first job requested by the first user U1, and the first user U1 uses an application to change setting values, the setting values set by the second user U2 may be changed to the setting values set by the first user U1, in which the second user U2 is required to set the setting values again when the second job is to be executed, which is inconvenient for the second user U2.

Therefore, when the second user U2 inputs a setting request via the operation panel 27, the setting processing unit 155 of the function providing application 136 requests the storage control unit 152 to check whether the first job is being executed currently by the main unit 10. When the storage control unit 152 checks and confirms that the first job is being executed currently by the main unit 10, the display control unit 156 displays a message that a new job such as the second job cannot be executed such as “job cannot be executed currently” on the operation panel 27. Then, when the first job of the first user U1 executed by the main unit 10 has completed, the setting processing unit 155 receives setting values of the second job from the second user U2, and then the main unit 10 executes the second job based on the setting values set by the second user U2.

With this configuration, the user can recognize that a new job cannot be executed currently before the user inputs the job execution request to the main unit 10, in which an unnecessary request is not input to the main unit 10, and thereby the processing load of the main unit 10 can be reduced. Further, inconvenience such as the above described re-setting operation can be prevented.

### (Memory Management Operation)

A description is given of a case that a memory capacity that can be used by each of the applications is set with an upper limit. When data amount used for each of the applications increases, there is a concern that the retrieval of data will take a longer time. Therefore, when the data amount of the application data exceeds the upper limit of the memory capacity set in advance, the storage control unit 152 deletes data in the application data one by one from the oldest data to control the data amount of the application data at the upper limit of the memory capacity or less.

With this configuration, the data amount used for each of the applications can be controlled at the upper limit of the memory capacity or less. Therefore, the data amount used for each of the applications does not exceed the upper limit of the memory capacity, with which a concern that the retrieval of data will take a long time can be prevented.

### (Display of Selected Setting Information)

A description is given of a case that the storage control unit 152 of the function providing application 136 stores one or more setting values set by a user in the storage unit such as the RAM 23 and/or the flash memory 24, in which the storage unit used as the secondary memory is used as setting value storage unit. The setting value set by the user is stored in the storage unit as the latest setting value, which is an example of specific setting information set by the user. Further, the storage unit also stores default setting value set as default information with the latest setting value

When the display control unit 156 receives a display request of the setting value from the vendor application 137, the display control unit 156 displays a selection screen on the operation panel 27 so that a user can select which one of the default setting value set as default information, and the latest setting value such as the most recent setting value is to be displayed on the operation panel 27. When the user selects any one of the setting values, the setting processing unit 155 performs a setting of the default setting value or the latest setting value.

With this configuration, when the same setting value is used at the vendor application 137, time and effort for setting the same setting value for each time can be saved. Further, when a job execution of the vendor application 137 is completed, the storage control unit 152 can delete the above described latest setting value and/or default setting value from the storage unit. With this configuration, the memory capacity of the storage unit can be saved for the latest setting value and/or the default setting value.

### (Information Security Operation)

A description is given of a case when the MFP 1 employs a user verification function. In this case, a plurality of users may respectively set information desired for each of the users. If the information (i.e., settings) used for one user is accessed by another user, it is not preferable from the view point of information security.

Therefore, when one user logs in and then logs out the MFP 1, the storage control unit 152 is configured to delete a part or the entire of information (e.g., setting information) related to the activated vendor application 137 from the above described storage unit. With this configuration, information of one user such as user settings is not accessed by another user, with which information security of the MFP 1 can be maintained.

### (Effect of First Embodiment)

As above described, the MFP 1 of the first embodiment includes the copy application 111, the scanner application 112, the printer application 113, and the facsimile application 114 set in the application layer 101 installed in the main unit 10, and the MFP 1 includes the function providing application 136 that can provide functions equivalent to the copy application 111 to the facsimile application 114 installed in the main unit 10 to the vendor application 137. In this configuration, the function providing application 136 controls the screen display and the job execution for each of the functions of the MFP 1. With this configuration, a program development process for developing a program executed by the function providing application 136 is not performed at development vendors such as third vendors that develop the vendor application 137, with which the development of the vendor application 137 at the development vendors can be simplified.

Further, when a model of the MFP 1 is changed from a first model to a second model such as from a monochrome machine to a color machine, or from a single-sided machine to a duplex machine, a model-by-model development of setting screen required for the MFP 1 is developed when designing and engineering specification of the function providing application 136. Therefore, the model-by-model development that varies among different models is not required to be performed at the development vendors that develop the vendor application 137.

### Second Embodiment

Hereinafter, a description is given of a MFP 1A of a second embodiment. The MFP 1A of the second embodiment includes a standard-installed job execution function application, and a function providing application that provides functions to a vendor application as one application program (i.e., integrated application). The MFP 1A of the second embodiment determines whether the MFP 1A is operated by calling the vendor application or the standard-installed job execution function application, and then the MFP 1A performs operations and/or provides a screen matched to the vendor application or the standard-installed job execution function application.

For example, when an icon of the standard-installed job execution function application is operated from a main screen by a user A, the function providing application is operated as a standard-installed application. Then, when another user B activates a vendor application to use the function of a job execution, the function providing application stores information (i.e., status information) when the function providing application was operated as a standard-installed application (status information), and then the function providing application is operated as an intermediary application of the vendor application. Then, when the user A activates the standard-installed job execution function application again, the screen that was operated by the user A is displayed again based on the stored status information. Compared to the above described first embodiment, the second embodiment is different in this aspect. Therefore, a description of the difference is given below, and the duplicate description may be omitted.

### (Software Configuration of Second Embodiment)

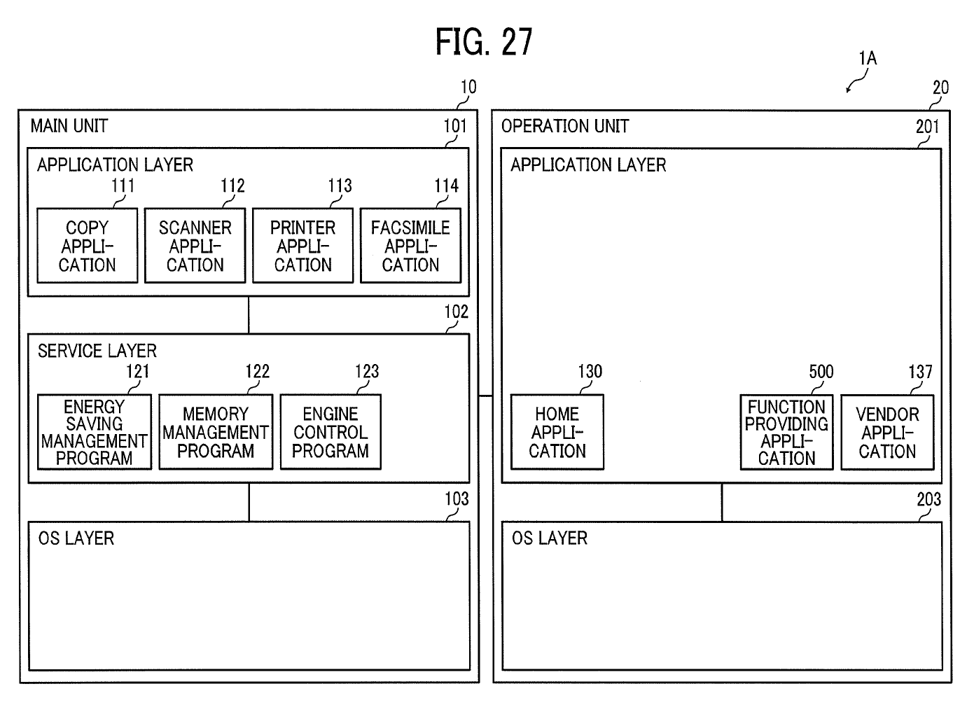

FIG. 27 is an example of software installed in the MFP 1A of the second embodiment. As illustrated in FIG. 27, the main unit 10 includes the application layer 101, the service layer 102, and the OS layer 103. The service layer 102 performs common processing such as energy saving and memory management and the like used by each of applications.

The operation unit 20 includes the application layer 201, and the OS layer 203. The applications installed in the main unit 10, and the applications installed in operation unit 20 perform different processing. Specifically, the application of the main unit 10 performs the engine control to control functions of the MFP 1A such as scanning data and printing data while the applications of the operation unit 20 performs the UI control. For example, the application of the operation unit 20 performs a screen display to receive a user's operation via the displayed screen, and the application of the main unit 10 performs the engine control based on the user operation received via the operation unit 20.

The operation unit 20 displays various applications installed in the MFP 1A on the display such as the scanner application, the copy application, the printer application, and the facsimile application installed in the MFP 1A. As illustrated in FIG. 27, the function providing application 500 is installed in the operation unit 20 to implement the second embodiment. In the second embodiment, the function providing application 500 can be used as a “standard-installed application” and a “function providing application for providing one or more functions to a vendor application,” which means the function providing application 500 integrates two application as one integrated application (hereinafter, integrated application). By contrast, in the case of the MFP 1 of the above described first embodiment, the “function providing application” and the “standard-installed application” are installed as separate applications. In the second embodiment, when the scan setting operation or the scan execution operation is to be executed, the vendor application 137 calls the function providing application 500.

### (Function of Function Providing Application)

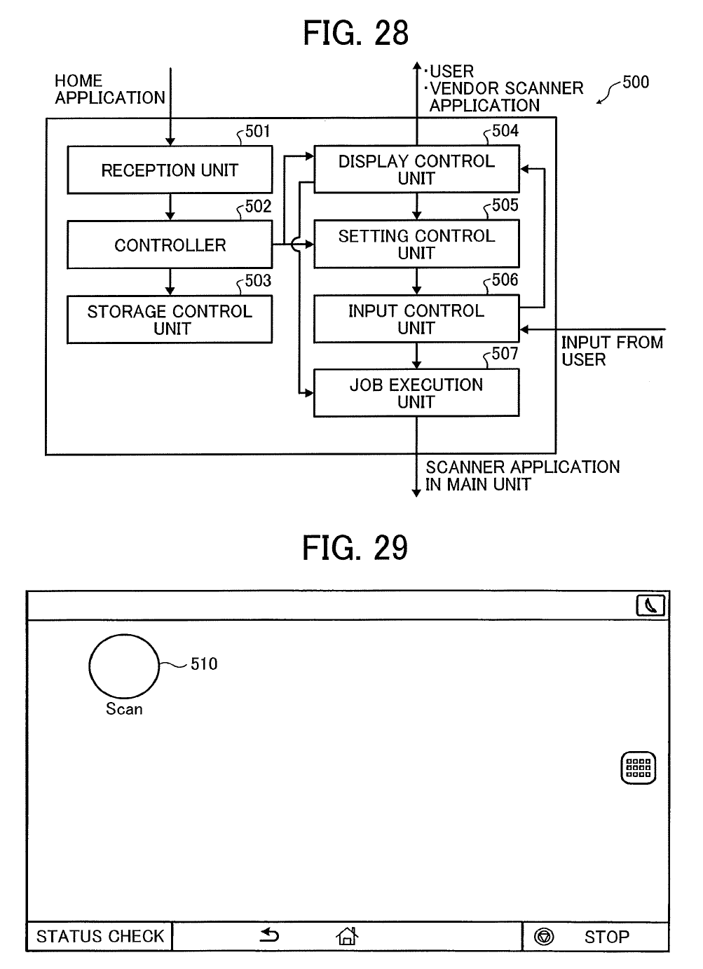

FIG. 28 is an example of a functional block diagram of the function providing application 500. When the CPU 21 of the operation unit 20 executes the function providing application 500 stored in the storage unit such as the ROM 22, the RAM 23, and/or the flash memory 24, functions such as a reception unit 501, a controller 502, a storage control unit 503, a display control unit 504, a setting control unit 505, an input control unit 506, and a job execution unit 507 are implemented as illustrated in FIG. 28.

The reception unit 501 receives an activation request that is generated when an icon of the function providing application 500 is operated, or an activation request from the vendor application 137. The display control unit 504 displays a job setting/executing screen. The setting control unit 505 changes display contents of the job setting/executing screen based on specifications of the MFP 1A, and adjusts the setting values. The input control unit 506 receives an input of a user from a screen displayed on the display. The job executing unit 507 requests a job execution using the determined setting values, then performs a complicated job execution. The storage control unit 503 stores and reads information, in which the information includes, for example, information of a caller (e.g., information indicating whether the function providing application 500 is activated as a standard-installed application, or as an application providing functionality to the vendor application), settings, and status information. After receiving a call from an application (i.e., caller, calling source), the controller 502 reads out information corresponding to the application used as the caller from the storage unit such as the ROM 22, the RAM 23, and/or the flash memory 24 of the operation unit 20, or the storage unit such as the ROM 12, the RAM 13, and/or the HDD 14 of the main unit 10, and performs a display operation or a job execution operation matched to the request from the caller.

### (Function Providing Operation in Function Providing Application)

A description is given of an operation of providing one or more functions to the vendor application 137 by using the function providing application 500. At first, as illustrated in FIG. 29, a home screen for selecting an application used by a user displays icons of various applications installed in the MFP 1A. For example, when a vendor scanner application icon 510 is selected among the icons, the vendor scanner application is activated, and a main screen of the vendor scanner application illustrated in FIG. 7 is displayed on the operation panel 27. FIG. 7 is an example of the main screen of the vendor scanner application.

When the scan setting button 161 (FIG. 7) of the vendor scanner application is operated, the application is switched by activating a scanner function providing application of the function providing application 500, and then the scanner setting top screen (FIG. 8) is displayed. In this configuration, the vendor scanner application calls an API to the scanner function providing application internally, and then the scanner function providing application is activated.

The scanner function providing application is capable of setting various scan settings in response to a user operation. For example, when the file format icon 163 used as a file format selection button (FIG. 8) is operated, a file format selection screen (FIG. 9) is displayed. In this configuration, screens such as the scanner setting top screen, and the detailed settings screen shifted from the scanner setting top screen can be implemented by the scanner function providing application.

When the setting completion button 164 (FIG. 9) of the scanner function providing application is operated, the scanner settings are confirmed, and the application is switched, and then the screen is returned to the main screen of the vendor scanner application (FIG. 7).

When the scan execution button 162 (FIG. 7) of the vendor scanner application is operated, the application is switched by activating the scanner function providing application, and then the scan execution screen (FIG. 10) is displayed, and the scan operation is executed. In this configuration, the vendor scanner application calls an API to the scanner function providing application internally, and then the scanner function providing application is activated.

When the scan execution operation is completed, the application is switched, and the screen is returned to the main screen of the vendor scanner application (FIG. 7), in which a scan result image is transferred.

As above described, the vendor application includes the scan setting button 161 and the scan execution button 162. In the above described configuration, the vendor application is configured with the API call processing to the scanner function providing application that is activated when the scan setting button 161 or the scan execution button 162 is operated, with which the scan setting operation and the scan execution operation can be performed by operating the scan setting button 161 or the scan execution button 162, and the scan result such a scanned image can be acquired. The vendor application can freely edit, transmit, ands store the scan result such as the scanned image.

### (Operation as Standard-Installed Application in Function Providing Application)

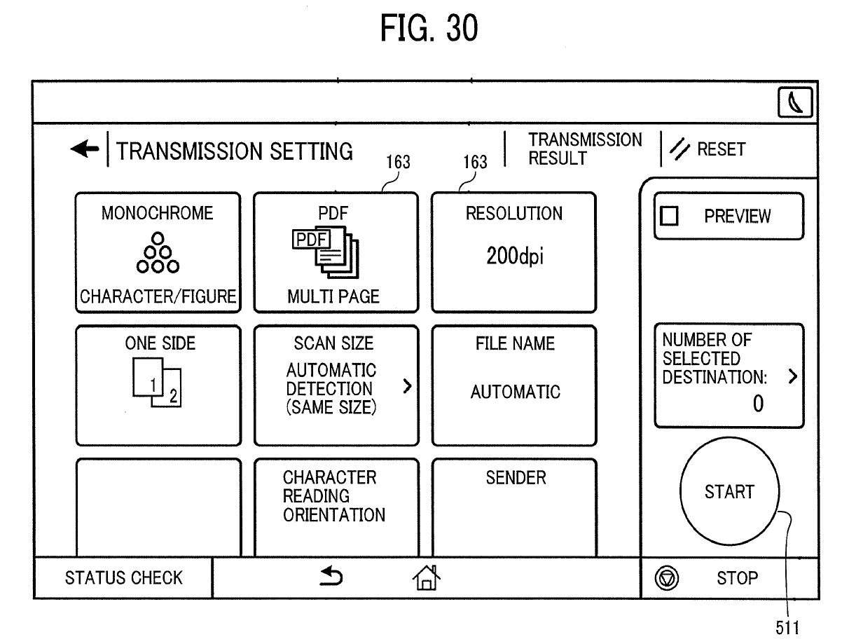

A description is given of an operation of the function providing application 500 when the function providing application 500 functions as a standard-installed scanner application. In this case, when an icon 510 for selecting the standard-installed scanner application is selected on the home screen (FIG. 29), a screen of the standard-installed scanner application is displayed as illustrated in FIG. 30.

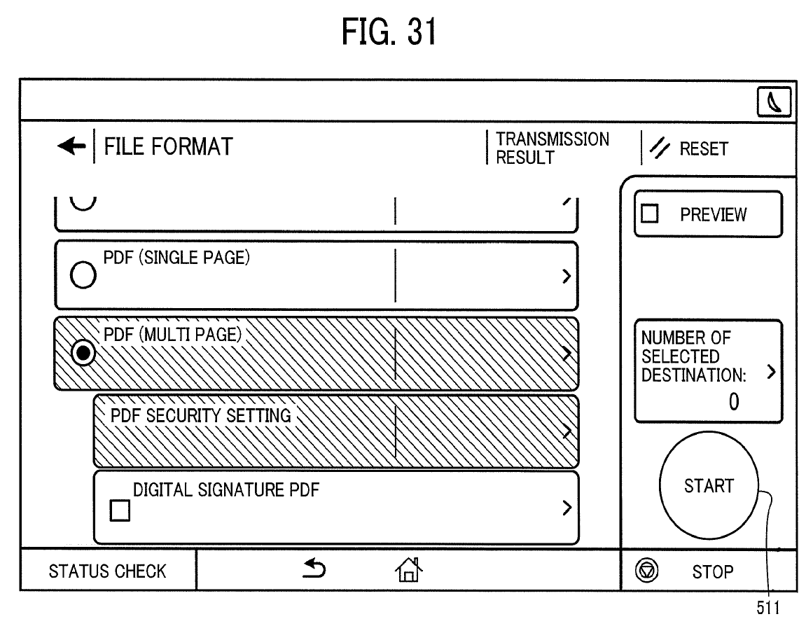

For example, when the file format icon 163 used as the file format selection button is operated on the screen of FIG. 30, a file format selection screen illustrated in FIG. 31 is displayed. When a start button 511 on the file format selection screen (FIG. 31) is operated, a scan execution screen similar to the scan execution screen of FIG. 10 is displayed, and then a scan operation is executed.

### (Display Operation of Setting Screen)

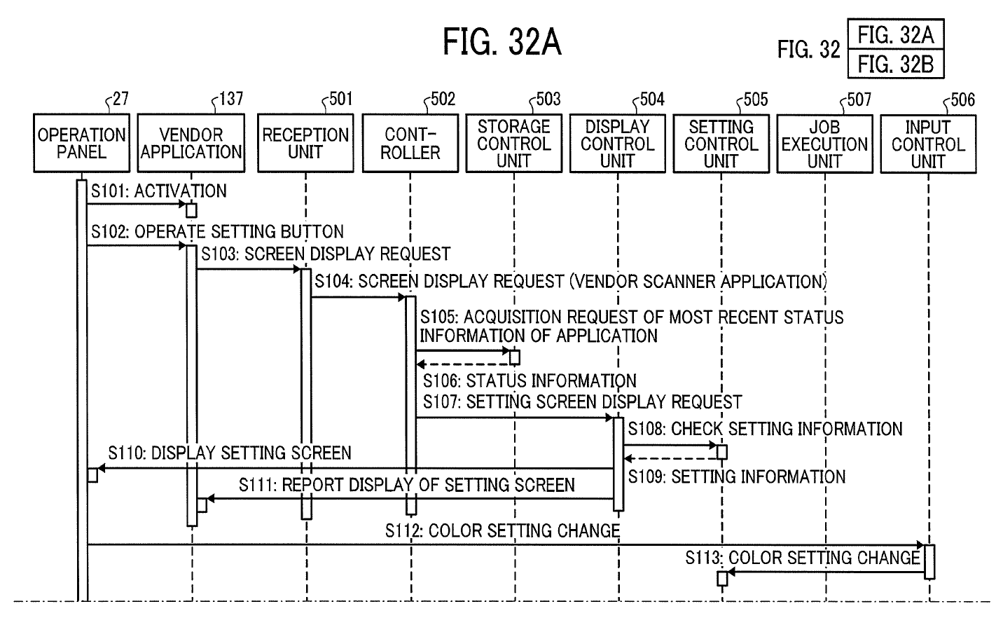

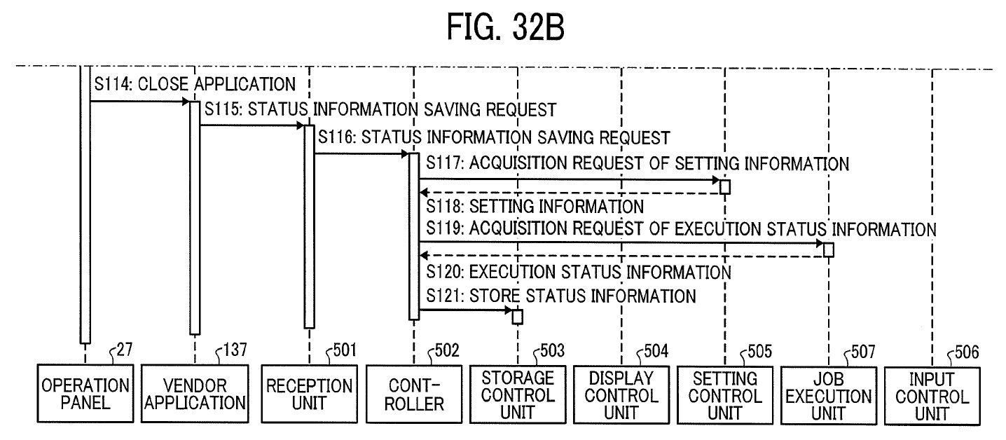

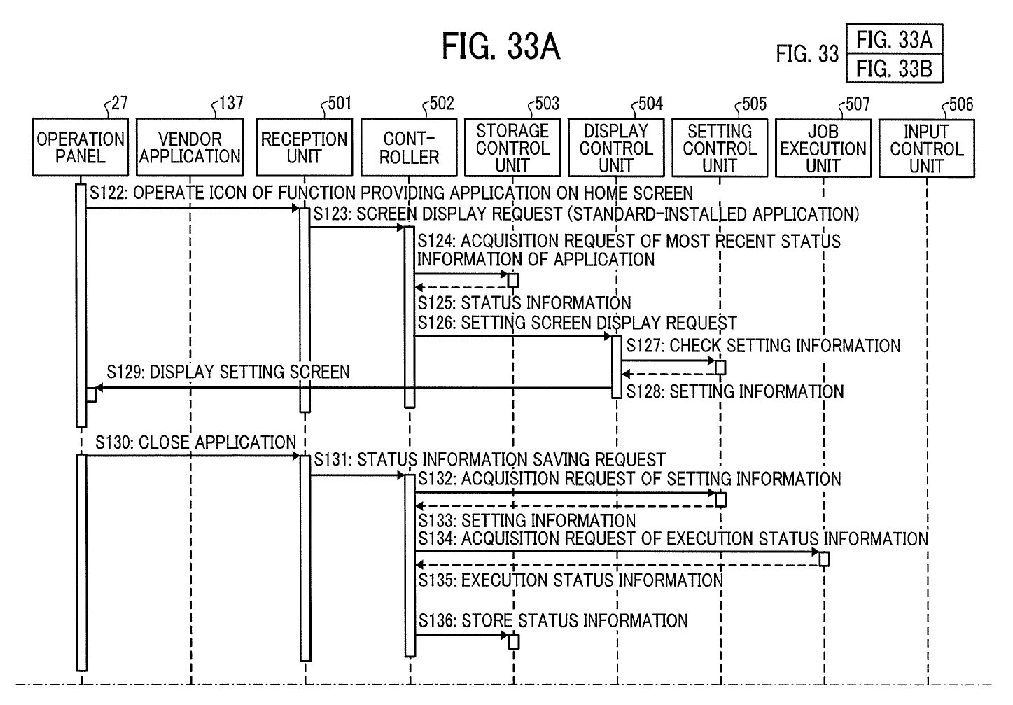

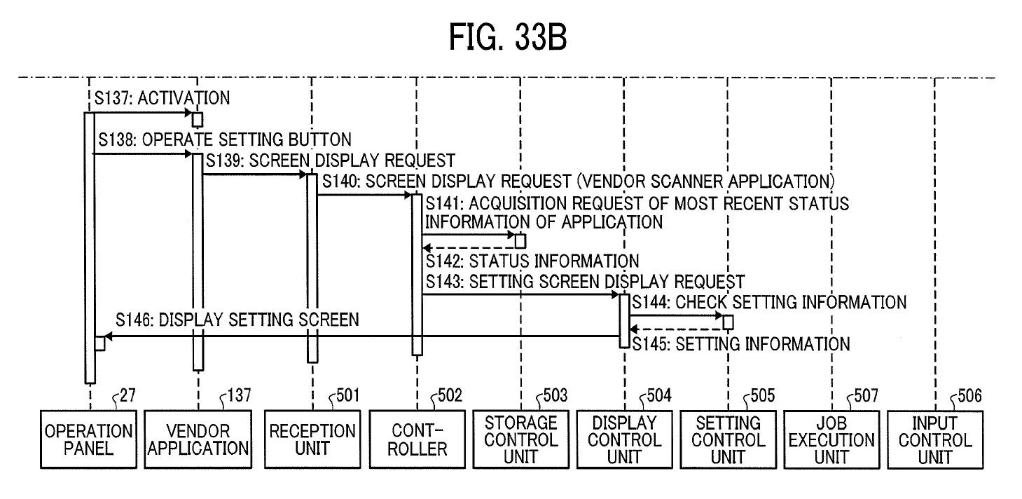

A description is given of an example of a sequence of a display operation of a setting screen for the MFP 1A of the second embodiment with reference to sequential charts of FIG. 32 and FIG. 33. In the sequential charts of FIGS. 32 and 33, “calling of function providing application from vendor application,” “closing of vendor application,” “calling of function providing application from home screen (e.g., function providing application is used as standard-installed scanner application),” and “closing of function providing application,” and “reopening of vendor application” are performed in this order.

In the sequential chart of FIGS. 32 and 33, when the application is closed (e.g., when the screen returns to the home screen), the most recent status information of the application (e.g., information indicating whether the application is called from the vendor application or the home screen, setting value information, information indicating a job status) is stored. Then, when the application is opened again, the setting screen is drawn again based on the most recent status information. Further, if the older status information still remains when storing the most recent status information of the application, the older status information is deleted, and the most recent status information is added as new status information (i.e., update of status information).

Specifically, as to the sequence chart of FIGS. 32A and 32B, when a user activates the vendor application 137 via the home screen (step S101), and the setting button is operated by the user (step S102), the vendor application 137 transmits a screen display request to the function providing application 500 (step S103). When the reception unit 501 of the function providing application 500 receives the screen display request from the vendor application 137, the reception unit 501 transmits the screen display request such as the screen display request of the vendor scanner application to the controller 502 (step S104). Then, the controller 502 transmits an acquisition request of the most recent status information of the vendor scanner application (i.e., request of acquiring most recent status information of application) to the storage control unit 503 (step S105).

For example, the status information is stored in the storage unit such as the HDD 14 of the main unit 10 and/or the storage unit such as the RAM 23 in the operation unit 20. For example, when acquiring the status information from the HDD 14 of the main unit 10, the storage control unit 503 accesses the HDD 14 of the main unit 10 via the connection I/F 26 of the operation unit 20 and the connection I/F 16 of the main unit 10, and acquires the status information. Further, when acquiring the status information from the RAM 23 of the operation unit 20, the storage control unit 503 accesses the RAM 23 via the bus 28 of the operation unit 20, and acquires the status information. The storage control unit 503 transmits the acquired status information to the controller 502 (step S106).

For example, when the OS of the operation unit 20 is LINUX (registered trademark) or the OS of the operation unit 20 is developed by extending Linux (registered trademark) such as Android (registered trademark), a file system “tmpfs” for temporary storing data is available although the file system “tmpfs” may not be used for some of Linux (registered trademark) and the extended OS. Since the “tmpfs” is set as a temporary storage area that has volatility, the “tmpfs” can be used as a storage area for temporarily storing the status information of the currently-activated application.

Since the “tmpfs” uses a volatile area such as RAM as a storage medium for storing data, data is deleted from the “tmpfs” when a power supply is turned off. However, since the status information of the application is required to be retained only when the MFP 1A is being activated because the status information is required when switching the application, and it is desirable that the MFP is returned to the default status after re-activating the MFP 1A. Therefore, the “tmpfs” can use the volatile area without causing a problem. Further, a stable operation can be performed by using the RAM having a life longer than a life of a flash memory.

Then, when the controller 502 acquires the status information (step S106), the controller 502 transmits the setting screen display request to the display control unit 504 (step S107). The display control unit 504 accesses the setting control unit 505 to check the setting information and acquire the setting information (steps S108 and S109), and displays the setting screen on the operation panel 27 (step S110). After displaying the setting screen, the display control unit 504 reports to the vendor application 137 that the setting screen is displayed by transmitting a display report of the setting screen (step S111).

Further, when the most recent status information is not stored such as when the vender application is activated for the first time, the display control unit 504 displays a default setting screen.

Then, when the color setting change operation is performed via the operation panel 27 by the user on the setting screen (step S112), the input control unit 506 transmits the color setting information input by the user to the setting control unit 505 (step S113) The setting control unit 505 temporarily stores the color setting information set by the user in the storage unit such as the RAM 23.

Then, when the application is closed (step S114) and the screen returns to the home screen, the vendor application 137 transmits a request for saving the status information (status information saving request) to the function providing application 500 (step S115). When the reception unit 501 of the function providing application 500 receives the status information saving request, the reception unit 501 transfers the status information saving request to the controller 502 (step S116). The controller 502 transmits a request for acquiring the setting information to the setting control unit 505 (step S117), and also transmits a request for acquiring the execution status information indicating the status information of a job execution (execution status information) to the job execution unit 507 (step S119).

The setting control unit 505 transmits the setting information to the controller 502 (step S118). Further, the job execution unit 507 transmits the execution status information to the controller 502 (step S120). Then, the controller 502 generates collective status information including the setting information, the execution status information, and information indicating a caller (i.e., information indicating that the calling occurs from the home screen or from the vendor application), and transmits the collective status information including the setting information, the execution status information, and the information indicating the caller to the storage control unit 503. As above described, the storage control unit 503 stores the collective status information in the storage unit such as the HDD 14 of the main unit 10 or the storage unit such as the RAM 23 of the operation unit 20 (step S121).

Table 6 illustrates an example of the status information.

TABLE 6

| Caller | Displaying screen | setting values | Job status |
|---|---|---|---|
| Vendor | screen displaying | Color: color | being |
| application | operation is being | Resolution: 600 dpi | executed |
| | executed | document size: A4 | |
| | | (portrait) | |
| Home screen | setting screen | Color: monochrome | not yet |
| | | Resolution: 200 dpi | executed |
| | | document size: B4 | |
| | | (portrait) | |

As illustrated in Table 6, the collective status information stored in the storage unit includes, for example, information indicating a calling source (caller) of the function providing application 500, information indicating a currently displaying screen, information of setting values, and information indicating the job status. In an example case of Table 6, when the calling source of the function providing application 500 is the vendor application, the currently displaying screen is a screen displaying that an operation is being executed, the setting values are color document/resolution of 600 dot per inch (dpi)/document size of A4 (portrait), and the job status indicates that the job is being executed. Further, in the example case of Table 6, when the calling source of the function providing application 500 is the home screen, the currently displaying screen is the setting screen, the setting values are monochrome document/resolution of 200 dpi/document size of B4 (portrait), and the job status indicates that the job is not yet executed.

Then, a description is given of the sequential chart of FIGS. 33A and 33B. When an icon of the function providing application 500 displayed on the home screen is operated by the user (step S122), a screen display request of the function providing application 500 is transmitted to the function providing application 500 from the operation panel 27. Then, the reception unit 501 of the function providing application 500 transmits the screen display request of the function providing application 500 to the controller 502 (step S123). The controller 502 transmits an acquisition request of the above described status information to the storage control unit 503 (step S124). The storage control unit 503 reads out the status information from the storage unit such as the HDD 14 of the main unit 10 or the storage unit such as the RAM 23 of the operation unit 20, and then transfers the status information to the controller 502 (step S125).

Then, based on the status information read out from the storage unit, the controller 502 transmits the setting screen display request to the display control unit 504 (step S126). The display control unit 504 communicates with the setting control unit 505 to check the setting information and acquire the setting information (steps S127 and S128), and displays the setting screen on the operation panel 27 (step S129).

When the status information is not stored in the storage unit such as when the function providing application 500 is activated for the first time, the display control unit 504 displays the default setting screen.

Then, when the closing of the application is designated via the operation panel 27 (step S130), the reception unit 501 of the function providing application 500 transmits a request for saving the status information (storage request of status information) to the controller 502 (step S131). The controller 502 transmits a setting information acquisition request to the setting control unit 505 (step S132), and also transmits a request for acquiring the execution status information indicating an execution status of the job to the job execution unit 507 (step S134).

The setting control unit 505 transmits the setting information to the controller 502 (step S133). Further, the job execution unit 507 transmits the execution status information to the controller 502 (step S135). The controller 502 generates collective status information including the setting information, the execution status information, and information indicating a caller (i.e., information indicating that the calling occurs from the home screen or from the vendor application), and transmits the collective status information including the setting information, the execution status information, and the information indicating the caller to the storage control unit 503. As above described, the storage control unit 503 stores the collective status information in the storage unit such as the HDD 14 of the main unit 10 or the storage unit such as the RAM 23 of the operation unit 20 (step S136).

Then, when the user activates the vendor scanner application via the home screen (step S137), and operates the setting button (step S138), the vendor application 137 transmits a screen display request to the function providing application 500 (step S139). When the reception unit 501 of the function providing application 500 receives the screen display request, the reception unit 501 transmits the screen display request such as the screen display request of the vendor scanner application to the controller 502 (step S140). The controller 502 transmits an acquisition request of the most recent status information of the vendor scanner application (request of acquiring most recent status information of application) to the storage control unit 503 (step S141). In this processing, the controller 502 acquires the status information corresponding to a timing “when the function providing application was called from the vendor application and used.” The storage control unit 503 transmits the acquired status information to the controller 502 (step S142).

Then, when the controller 502 acquires the status information (step S142), the controller 502 transmits the setting screen display request to the display control unit 504 (step S143). The display control unit 504 accesses the setting control unit 505 to check the setting information and acquire the setting information (steps S144 and S145), and displays the setting screen on the operation panel 27 (step S146). In this example case, color setting is changed by the user at steps S112 and S113 (FIG. 32). Therefore, at step S146, a setting screen that has changed the color setting is displayed based on the status information.

### (Operation of Job Execution)

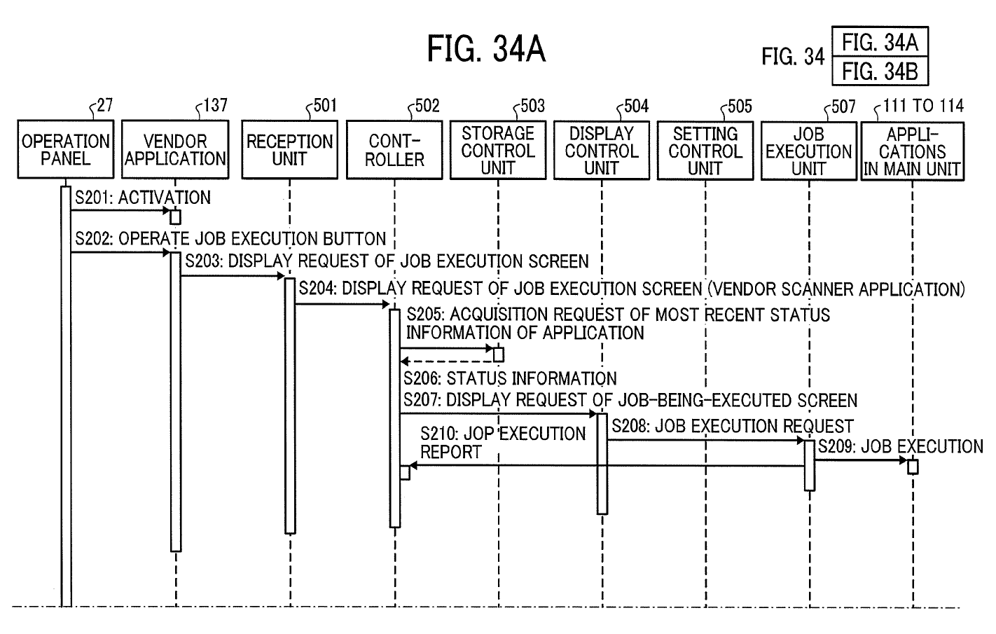

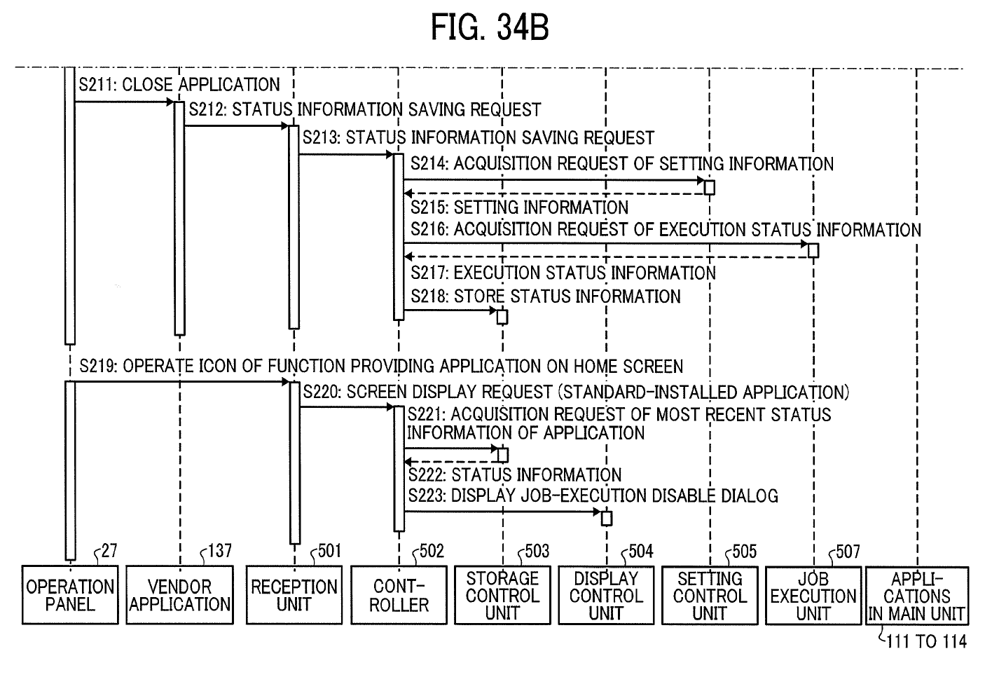

A description is given of an example of a sequence of a job execution operation by the MFP 1A of the second embodiment with reference to a sequential chart of FIGS. 34A and 34B. When a user activates the vendor application 137 via the operating panel 27 (step S201), and the user operates a start button for designating a job execution (step S202), the vendor application 137 transmits, for example, a display request of a job execution screen of the vendor scanner application to the function providing application 500 (step S203).

When the reception unit 501 of the function providing application 500 receives the display request of the job execution screen, the reception unit 501 transfers the display request of the job execution screen to the controller 502 (step S204). When the controller 502 receives the display request of the job execution screen, the controller 502 transmits an acquisition request of the status information to the storage control unit 503 (step S205). The storage control unit 503 reads out the status information from the storage unit such as the HDD 14 of the main unit 10 as described above, and transmits the status information to the controller 502 (step S206).

Then, the controller 502 requests a display of a job-being-executed screen to the display control unit 504 (step S207). When the display control unit 504 receives the display request of the job-being-executed screen, the display control unit 504 transmits a job execution request to the job execution unit 507 (step S208). The job execution unit 507 communicates with the application in the main unit 10 (e.g., applications 111 to 114) to execute the job such as scanning or copying (step S209). When the job is executed by the application (e.g., applications 111 to 114) in the main unit 10, the job execution unit 507 transmits a job execution report to the controller 502 (step S210).

Then, when the application is closed (step S211) and the screen returns to the home screen, the vendor application 137 transmits a request for saving the status information (status information saving request) to the function providing application 500 (step S212). When the reception unit 501 of the function providing application 500 receives the status information saving request, the reception unit 501 transfers the status information saving request to the controller 502 (step S213). The controller 502 transmits a request for acquiring the setting information to the setting control unit 505 (step S214), and also transmits a request for acquiring the execution status information indicating the status information of job execution to the job execution unit 507 (step S216).

The setting control unit 505 transmits the setting information to the controller 502 (step S215). Further, the job execution unit 507 transmits the execution status information to the controller 502 (step S217). The controller 502 generates collective status information including the setting information, the execution status information, and information indicating a caller (i.e., information indicating that the calling occurs from the home screen or from the vendor application), and transmits the collective status information including the setting information, the execution status information, and the information indicating the caller to the storage control unit 503. As above described, the storage control unit 503 stores the collective status information in the storage unit such as the HDD 14 of the main unit 10 or the storage unit such as the RAM 23 of the operation unit 20 (step S218).

Then, when an icon of the function providing application 500 displayed on the home screen is operated (step S219) to use the standard-installed scanner application during the scan is being executed by the vendor scanner application, the reception unit 501 of the function providing application 500 transmits a display request of the job execution screen of the standard-installed scanner application to the controller 502 (step S220). After the controller 502 receives the display request of the job execution screen of the standard-installed scanner application, the controller 502 acquires the status information of the standard-installed scanner application from the storage control unit 503 (steps S221 and S222). However, in this example case, since the scan is being executed by the vendor scanner application, the scan by using the standard-installed scanner application cannot be executed. Therefore, the controller 502 transmits a display request of a job-execution disable dialog indicating that the job by using the standard-installed scanner application cannot be executed currently to the display control unit 504 (step S223). Then, the display control unit 504 displays the job-execution disable dialog on the operation panel 27. With this configuration, the user can recognize that the scan operation by using the standard-installed scanner application cannot be executed currently because the scan operation is being executed currently by the vendor scanner application.

### (Effect of Second Embodiment)

The MFP 1A of the second embodiment can achieve the following effect in addition to the effect described in the above described first embodiment.

As to the second embodiment, the standard-installed job execution function application is added with the providing one or more functions to the vender application, with which two application programs becomes one application program. Therefore, inconvenience that different storage areas are used wastefully for the same function can be prevented, which means the storage area for storing the application program can be reduced.

Further, when a bug is contained in the job execution function, the correction operation is performed for the above mentioned one application, with which the number of works such correction works can be reduced, and the management cost can be reduced.

In a case of the standard-installed job execution function application is added with the function providing one or more functions to the vender application to integrate the two applications into one application program, the status management due to a difference of the caller of the function providing application becomes an issue. For example, when a user A changes the color setting when the function providing application is being activated as the standard-installed application, and then a user B activates the vendor application, the setting of the resolution may be changed by the user B. Thereafter, when the user A activates the standard-installed application again, it is desirable that the application is activated by only the color setting has been changed.

For this reason, in the case of the MFP 1A of the second embodiment, the most recent information is stored for each of the caller when the application is closed. Then, when the application is re-activated, the stored status information is read out to reproduce the status when the apparatus was closed most recently. Therefore, even if the standard-installed job execution function application is added with the function providing one or more functions to the vender application to integrate as one application program, the status information can be managed for each of the caller.

The above described information processing apparatus, information processing program, and a storage medium storing a computer-readable information processing program can be used for easily developing and modifying applications of apparatuses.

Each of the functions of the described embodiments may be implemented by one or more processors, processing circuits, or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

Numerous additional modifications and variations for the modules, the units, and the image projection apparatus are possible in light of the above teachings. It is therefore to be understood that within the scope of the appended claims, the description of present disclosure may be practiced otherwise than as specifically described herein. For example, elements and/or features of different examples and illustrative embodiments may be combined each other and/or substituted for each other within the scope of present disclosure and appended claims.

What is claimed is:

1. An information processing apparatus comprising:
one or more processors that cooperate with each other to control an operation related to information processing, and a display operation of displaying a setting information reception screen on a display, the setting information reception screen is used to receive setting information related to the information processing, and an execution instruction of the information processing;
a primary memory configured to store a primary application used for requesting the one or more processors to execute the information processing based on the setting information and the execution instruction related to the information processing received via the setting information reception screen; and
a secondary memory configured to store a secondary application, different from the primary application, and a function providing application,
wherein when the secondary application receives an instruction related to the information processing via the setting information reception screen, the secondary application transfers the instruction related to the information processing to the function providing application,
wherein the function providing application displays the setting information reception screen on the display when the function providing application receives a request for displaying the setting information reception screen from the secondary application, and
wherein the function providing application requests the execution of the information processing based on the setting information and the execution instruction, received via the setting information reception screen and the secondary application, to the primary application when the function providing application receives a request for executing the information processing from the secondary application.

2. The information processing apparatus of claim 1, wherein when the one or more processors execute the information processing based on the setting information to acquire an information processing result, the primary application issues identification information associated to the information processing result, and transmits the identification information associated to the information processing result to the function providing application.

3. The information processing apparatus of claim 1, wherein when the secondary application requests an operation to the function providing application, the secondary application requests any one of a display of the setting information reception screen and an execution of the information processing as the operation to the function providing application based on one or more parameters associated to the operation.

4. The information processing apparatus of claim 1, wherein the setting information reception screen displays a first setting item at a first position and a second setting item at a second position on the display, the second position is adjacent to the first position,
wherein when the first setting item is set to invisible while the second setting item is set to visible, the function providing application does not display the first setting item on the setting information reception screen, and displays the second setting item at the first position on the setting information reception screen instead of the second position.

5. The information processing apparatus of claim 1, wherein the setting information reception screen displays a first setting item at a first position and a second setting item at a second position,
wherein when the first setting item is set to disable while the second setting item is set to enable, the function providing application displays the first setting item at the first position with a transparency level higher than a transparency level of the second setting item at the second position.

6. The information processing apparatus of claim 1,
wherein when the secondary application includes a plurality of secondary applications, the secondary memory stores information indicating a setting status and information indicating an execution status of information processing of each of the secondary applications, the plurality of secondary applications including at least a first secondary application and a second secondary application,
wherein, when the second secondary application requests any one of a setting operation and an execution operation to the function providing application while the function providing application is executing any one of a setting and an execution operation requested by the first secondary application, the function providing application refers the secondary memory to check the setting status and the execution status of the information processing requested by the first secondary application, and executes any one of the setting operation and execution operation requested by the second secondary application after the function providing application has completed any one of the setting operation and execution operation requested by the first secondary application.

7. The information processing apparatus of claim 6, wherein when the second secondary application requests any one of the setting operation and execution operation to the function providing application while the function providing application is still executing any one of the setting operation and execution operation requested by the first secondary application, the function providing application reports that any one of the setting operation and execution operation requested by the first secondary application is not yet completed.

8. The information processing apparatus of claim 1, wherein when a data size of the secondary application is to exceed an upper limit capacity of the secondary memory, the function providing application deletes data retained by the secondary application from the oldest data to cause the data size of the secondary application to be within the upper limit capacity of the secondary memory.

9. The information processing apparatus of claim 1,
wherein the secondary memory stores default setting information, and specific setting information set via the setting information reception screen,
wherein when the secondary application transmits a display request of the setting information to the function providing application, the function providing application displays a setting information selection screen used for selecting a display of the default setting information or a display of the specific setting information, and the function providing application performs a setting operation corresponding to any one of the default setting information and the specific setting information based on a selection result on the setting information selection screen.

10. The information processing apparatus of claim 1, wherein the one or more processors control a login of a user registered to the information processing apparatus,
wherein when the registered user who has logged in, and logs out the information processing apparatus, the function providing application deletes, from the secondary memory, a part of or the entire information used for the secondary application that has been activated when the user logged into the information processing apparatus.

11. The information processing apparatus of claim 1, wherein the primary application and the function providing application is integrated as one integrated application.

12. The information processing apparatus according to claim 11,
wherein the integrated application collectively stores caller information indicating a caller selectable from any one of the primary application and the secondary application, one or more setting values, and information indicating an operation status as status information in any one of the primary memory and the secondary memory when a requested operation is completed,
wherein the one or more processors read out the status information from any one of the primary memory and the secondary memory when the primary application is activated or when the secondary application calls the primary application, and reproduce the setting status, corresponding to the one or more setting values stored in any one of the primary memory and the secondary memory when the requested operation was completed, based on the status information read out from any one of the primary memory and the secondary memory.

13. The information processing apparatus according to claim 11,
wherein when the one or more processors are executing the integrated application to execute a first job requested by the primary application, the one or more processors do not allow an execution of a second job requested by the secondary application,
wherein when the one or more processors are executing the integrated application to execute the second job requested by the secondary application, the one or more processors do not allow an execution of the first job requested by the primary application.

14. The information processing apparatus according to claim 11, wherein the primary memory is disposed in a main unit of the information processing apparatus, and the one or more processors control the primary memory disposed in the main unit to store the status information in the primary memory.

15. The information processing apparatus according to claim 11, wherein the one or more processors store the status information in a storage area used for storing the status information temporarily, and the storage area is managed by an operating system installed on the information processing apparatus.

16. A method of processing information in an information processing apparatus including the one or more processors configured to control an operation related to information processing in the information processing apparatus, a primary memory configured to store a primary application, and a secondary memory configured to store a secondary application, different from the primary application, and a function providing application, the method comprising:
inputting an instruction related to the information processing, by using an initial screen displayed on a display, the instruction being any one of a display request of a setting information reception screen and an execution instruction of the information processing;
displaying the setting information reception screen on the display by using the function providing application in response to receiving the display request of the setting information reception screen from the secondary application;
receiving an input of setting information and a request for executing the information processing, input by using the setting information reception screen displayed on the display, by the secondary application; and
requesting the execution of information processing to the primary application from the function providing application based on the setting information and the execution instruction, received via the setting information reception screen, in response to receiving the execution instruction of the information processing by the function providing application from the secondary application.

17. A non-transitory storage medium storing one or more instructions that, when executed by the one or more processors, cause the one or more processors to execute a method of processing information in an information processing apparatus including the one or more processors configured to control an operation related to information processing in the information processing apparatus, a primary memory configured to store a primary application, and a secondary memory configured to store a secondary application, different from the primary application, and a function providing application, the method comprising:
inputting an instruction related to the information processing, by using an initial screen displayed on a display, the instruction being any one of a display request of a setting information reception screen and an execution instruction of the information processing;
displaying the setting information reception screen on the display by using the function providing application in response to receiving the display request of the setting information reception screen from the secondary application;
receiving an input of setting information and a request for executing the information processing, input by using the setting information reception screen displayed on the display, by the secondary application; and
requesting the execution of information processing to the primary application from the function providing application based on the setting information and the execution instruction, received via the setting information reception screen, in response to receiving the execution instruction of the information processing by the function providing application from the secondary application.
